(19) United States
(12) Patent Application Publication
(10) Pub. No.: US 2023/0054857 A1
(43) Pub. Date: Feb. 23, 2023

(54) FLAVONOID COMPOSITIONS AND RELATED USES

(71) Applicant: Firmenich SA, Satigny (CH)

(72) Inventors: Eva MUELLER, Ortenburg (DE); Wolfgang FIEBER, Satigny (CH); Barbara BUCHS, Satigny (CH)

(73) Assignee: Firmenich SA, Satigny (CH)

(21) Appl. No.: 17/790,630

(22) PCT Filed: Feb. 2, 2021
(86) PCT No.: PCT/EP2021/052447

§ 371 Date: Jul. 1, 2022

Related U.S. Application Data
(60) Provisional application No. 62/969,737, filed on Feb. 4, 2020.

(30) Foreign Application Priority Data
Feb. 11, 2020 (EP) 20156541.3

(51) Int. Cl. A23L 33/105; A23L 2/56; A23C 9/152; A23L 2/60

(52) U.S. Cl. CPC A23L 33/105; A23L 2/56; A23C 9/152; A23L 2/60

(57) ABSTRACT

The present disclosure generally relates to the use of certain compounds, such as anthocyanins, saponins, or combinations thereof, at low concentrations to improve the aqueous solubility of flavonoid compounds. Thus, in certain aspects, the disclosure provides aqueous compositions including flavonoid compounds, such as naringenin or phloretin, and one or more compounds selected rom anthocyanin compounds, saponins, and combinations thereof. In related aspects, the disclosure provides methods and uses of certain compounds, such as anthocyanins, saponins, or combinations thereof, to enhance the aqueous solubility of flavonoid compounds. In related aspects, the disclosure provides methods to maintain the stability of a supersaturated aqueous solution of flavonoid compounds, for example, by increasing the kinetic stability of such supersaturated aqueous solutions. In some further embodiments of the foregoing aspects, the aqueous compositions are used to make flavored articles, such as beverage or dairy products, that contain concentration of surfactants, co-solvents, hydrotropes, or complexing agents below the typical taste-affecting thresholds in humans.

### CROSS-REFERENCE TO RELATED APPLICATIONS

The present application claims the benefit of priority to U.S. Provisional Application No. 62/969,737, filed Feb. 4, 2020, and European Patent Application No. 20156541.3, filed Feb. 11, 2020, both of which are incorporated herein by reference as though set forth herein in their entireties.

### TECHNICAL FIELD

The present disclosure generally relates to the use of certain compounds, such as anthocyanins, saponins, or combinations thereof, at low concentrations to improve the aqueous solubility of flavonoid compounds. Thus, in certain aspects, the disclosure provides aqueous compositions including flavonoid compounds, such as naringenin or phloretin, and one or more compounds selected from anthocyanin compounds, saponins, and combinations thereof. In related aspects, the disclosure provides methods and uses of certain compounds, such as anthocyanins, saponins, or combinations thereof, to enhance the aqueous solubility of flavonoid compounds. In related aspects, the disclosure provides methods to maintain the stability of a supersaturated aqueous solution of flavonoid compounds, for example, by increasing the kinetic stability of such supersaturated aqueous solutions. In some further embodiments of the foregoing aspects, the aqueous compositions are used to make flavored articles, such as beverage or dairy products, that contain concentrations of surfactants, co-solvents, hydrotropes, or complexing agents below the typical taste-affecting thresholds in humans.

### DESCRIPTION OF RELATED ART

The taste system provides sensory information about the chemical composition of the external world. Taste transduction is one of the more sophisticated forms of chemically triggered sensation in animals. Signaling of taste is found throughout the animal kingdom, from simple metazoans to the most complex of vertebrates. Mammals are believed to have five basic taste modalities: sweet, bitter, sour, salty, and umami.

Sweetness is the taste most commonly perceived when eating foods rich in sugars. Mammals generally perceive sweetness to be a pleasurable sensation, except in excess. Caloric sweeteners, such as sucrose and fructose, are the prototypical examples of sweet substances. Although a variety of no-calorie and low-calorie substitutes exist, these caloric sweeteners are still the predominant means by which comestible products induce the perception of sweetness upon consumption.

Metabolic disorders and related conditions, such as obesity, diabetes, and cardiovascular disease, are major public health concerns throughout the world. And their prevalence is increasing at alarming rates in almost every developed country. Caloric sweeteners are a key contributor to this trend, as they are included in various packaged food and beverage products to make them more palatable to consumers. In many cases, no-calorie or low-calorie substitutes can be used in foods and beverages in place of sucrose or fructose. Even so, these compounds impart sweetness differently from caloric sweeteners, and a number of consumers fail to view them as suitable alternatives. Moreover, such compounds may be difficult to incorporate into certain products. In some instances, they may be used as partial replacements for caloric sweeteners, but their mere presence can cause many consumers to perceive unpleasant off-tastes including, astringency, bitterness, and metallic and licorice tastes. Thus, lower-calorie sweeteners face certain challenges to their adoption.

Sweetness enhancement provides an alternative approach to overcoming some of adoption challenges faced by lower-calorie sweeteners. Such compounds can be used in combination with sucrose or fructose to enhance their sweetness, thereby permitting the use of lower quantities of such caloric sweeteners in various food or beverage products. Or they can be used in combination with certain low-calorie sweeteners in a similar way, which can help reduce the perception of off notes consumers may perceive if the sweetness enhancers were used in higher concentrations. Even so, some such compounds may have extremely low solubility in aqueous media, which limits the concentrations at which they can be used. If they could be used effectively at higher concentrations in aqueous media, it would permit further reduction in the concentration of the primary sweetening agent. But traditional means of enhancing aqueous solubility, such as introducing surfactants, solvents, hydrotropes or complexing agents, can alter the taste profile of the product in undesirable ways. Thus, there is a continuing need to discover ways of improving the aqueous solubility of sweetness enhancers, or bitterness maskers, or astringency maskers, in ways that do not otherwise introduce off-notes or ingredients into a product.

### SUMMARY

The present disclosure relates to the discovery that combining flavonoids with certain compounds, such as anthocyanins, saponins, or combinations thereof, in aqueous media enhances the solubility of the flavonoids, for example, to permit the formation of more concentrated compositions of certain flavor enhancers, bitterness maskers, and astringency maskers, such as phloretin and naringenin.

In a first aspect, the disclosure provides uses of a composition, which comprises one or more anthocyanin compounds, saponin compounds, or combinations thereof, to increase an aqueous solubility of a flavonoid compound. In some embodiments, the uses comprise introducing one or more anthocyanin compounds in combination with the flavonoid compound to an aqueous medium.

In a second aspect, the disclosure provides uses of a composition, which comprises one or more anthocyanin compounds, saponin compounds, or combinations thereof, to inhibit or delay aqueous recrystallization of a flavonoid compound. In some embodiments, the uses comprise introducing one or more anthocyanin compounds in combination with the flavonoid compound to an aqueous medium.

In a third aspect, the disclosure provides uses of a composition, which comprises one or more anthocyanin compounds, saponin compounds, or combinations thereof, to enhance a taste-modulating effect of a flavonoid compound. In some embodiments, the uses comprise introducing one or more anthocyanin compounds in combination with the flavonoid compound to an aqueous medium.

In a fourth aspect, the disclosure provides uses of a composition, which comprises one or more anthocyanin compounds, saponin compounds, or combinations thereof, to increase a supersaturated aqueous stability of a flavonoid compound. In some embodiments, the uses comprise introducing one or more anthocyanin compounds in combination with the flavonoid compound to an aqueous medium.

In a fifth aspect, the disclosure provides methods of increasing aqueous solubility of a flavonoid compound, the method comprising introducing a composition, which comprises one or more anthocyanin compounds, saponin compounds, or combinations thereof, in combination with a flavonoid compound to an aqueous medium.

In a sixth aspect, the disclosure provides methods of inhibiting or delaying aqueous recrystallization of a flavonoid compound, the method comprising introducing a composition, which comprises one or more anthocyanin compounds, saponin compounds, or combinations thereof, in combination with a flavonoid compound to an aqueous medium.

In a seventh aspect, the disclosure provides methods of enhancing taste modulation of a flavonoid compound, the method comprising introducing a composition, which comprises one or more anthocyanin compounds, saponin compounds, or combinations thereof, in combination with a flavonoid compound to an aqueous medium.

In an eighth aspect, the disclosure provides methods of increasing supersaturated aqueous stability of a flavonoid compound, the method comprising introducing a composition, which comprises one or more anthocyanin compounds, saponin compounds, or combinations thereof, in combination with a flavonoid compound to an aqueous medium.

In a ninth aspect, the disclosure provides comestible compositions comprising: an aqueous carrier, which comprises at least 50% by weight water; a flavonoid compound, which is at least partially solvated by the aqueous carrier; and one or more anthocyanin compounds, saponin compounds, or combinations thereof. In some embodiments, the flavonoid compound is at least partially solvated by the aqueous carrier at a concentration greater than the saturation concentration of the flavonoid compound in water (for example, at 25° C. and 100 kPa).

In a tenth aspect, the disclosure provides beverage products, wherein the beverage products comprise the comestible composition of the ninth aspect or any embodiments thereof. In some embodiments, the beverage product is a dairy product or a substitute dairy product, such as yogurt, milk, a protein drink, a meal-replacement drink, almond milk, coconut milk, cashew milk, soy milk, rice milk, oat milk, and the like. In some other embodiments, the beverage product is a soda.

In an eleventh aspect, the disclosure provides flavoring concentrates, wherein the flavoring concentrates comprising a comestible composition of the ninth aspect or any embodiments thereof.

Further aspects, and embodiments thereof, are set forth below in the Detailed Description, the Drawings, the Abstract, and the Claims.

### BRIEF DESCRIPTION OF THE DRAWINGS

The following drawings are provided for purposes of illustrating various embodiments of the compositions and methods disclosed herein. The drawings are provided for illustrative purposes only, and are not intended to describe any preferred compositions or preferred methods, or to serve as a source of any limitations on the scope of the claimed inventions.

FIG. 1 shows a chemical formula that represents non-limiting examples of anthocyanin compounds that may suitable used in certain embodiments disclosed herein.

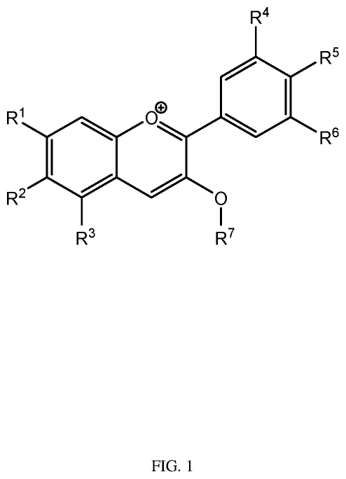

### DETAILED DESCRIPTION

The following Detailed Description sets forth various aspects and embodiments provided herein. The description is to be read from the perspective of the person of ordinary skill in the relevant art. Therefore, information that is well known to such ordinarily skilled artisans is not necessarily included.

### Definitions

The following terms and phrases have the meanings indicated below, unless otherwise provided herein. This disclosure may employ other terms and phrases not expressly defined herein. Such other terms and phrases have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, a “glucosyl moiety” is a monovalent moiety in which one of the hydroxyl groups of glucose is replaced by a bond to another atom, functional group, or moiety. Unless otherwise specified, the glucose can have any suitable stereochemistry. Thus, the term includes moieties having D stereochemistry, as well as moieties having L stereochemistry. Further, the term includes moieties having α stereochemistry, as well as moieties having β stereochemistry. The carbon atoms of the glucosyl moiety follow the conventional numbering, as shown below. The diagram is shown for β-D glucose, but applies in an analogous way to glucosyl moieties having a and/or L stereochemistry:

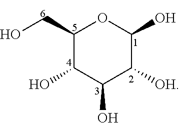 [SMILES: OC[C@H]1O[C@@H](O)[C@H](O)[C@@H](O)[C@@H]1O]

It is to be understood that certain radical naming conventions can include either a mono-radical or a di-radical, depending on the context. For example, where a substituent requires two points of attachment to the rest of the molecule, it is understood that the substituent is a di-radical. For example, a substituent identified as alkyl that requires two points of attachment includes di-radicals such as —CH₂—, —CH₂CH₂—, —CH₂CH(CH₃)CH₂—, and the like.

A “sweetener”, “sweet flavoring agent”, “sweet flavor entity”, or “sweet compound” herein refers to a compound or ingestibly acceptable salt thereof that elicits a detectable sweet flavor in a subject, e.g., a compound that activates a T1R2/T1R3 receptor in vitro.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure, and are not meant to be limiting in any fashion. Nor do these phrases indicate any kind of preference for the disclosed embodiment.

As used herein, “comprise” or “comprises” or “comprising” or “comprised of” refer to groups that are open, meaning that the group can include additional members in addition to those expressly recited. For example, the phrase, “comprises A” means that A must be present, but that other members can be present too. The terms “include,” “have,” and “composed of” and their grammatical variants have the same meaning. In contrast, “consist of” or “consists of” or “consisting of” refer to groups that are closed. For example, the phrase “consists of A” means that A and only A is present.

As used herein, “optionally” means that the subsequently described event(s) may or may not occur. In some embodiments, the optional event does not occur. In some other embodiments, the optional event does occur one or more times.

As used herein, “or” is to be given its broadest reasonable interpretation, and is not to be limited to an either/or construction. Thus, the phrase “comprising A or B” means that A can be present and not B, or that B is present and not A, or that A and B are both present. Further, if A, for example, defines a class that can have multiple members, e.g., A₁ and A₂, then one or more members of the class can be present concurrently.

As used herein, certain substituents or linking groups having only a single atom may be referred to by the name of the atom. For example, in some cases, the substituent “—H” may be referred to as “hydrogen” or “a hydrogen atom,” the substituent “—F” may be referred to as “fluorine” or “a fluorine atom,” and the linking group “—O—” may be referred to as “oxygen” or “an oxygen atom.”

Points of attachment for groups are generally indicated by a terminal dash (-) or by an asterisk (*). For example, a group such as *-CH₂—CH₃ or —CH₂—CH₃ both represent an ethyl group.

Chemical structures are often shown using the “skeletal” format, such that carbon atoms are not explicitly shown, and hydrogen atoms attached to carbon atoms are omitted entirely. For example, the structure

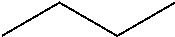

represents butane (i.e., n-butane). Furthermore, aromatic groups, such as benzene, are represented by showing one of the contributing resonance structures. For example, the structure

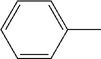

represents toluene.

Other terms are defined in other portions of this description, even though not included in this subsection.

### Flavonoid Compounds

In various embodiments of the uses, methods, and compositions provided herein, one or more flavonoid compounds are employed. As used herein the term “flavonoid compound” refers to a class of compounds that includes bioflavonoids (namely, flavone, flavanones and flavonols, and hydroxyl-, methoxy-, and/or glycoside-substituted derivatives thereof), isoflavonoids (namely, isoflavan and hydroxyl-, methoxy-, and/or glycoside-substituted derivatives thereof), neoflavonoids (namely, 4-phenylcoumarin and hydroxyl-, methoxy-, and/or glycoside-substituted derivatives thereof), as well as open-chain analogs, such as chalcones and dihydrochalcones (namely, chalcones and dihydrochalcone and hydroxyl-, methoxy-, and/or glycoside-substituted derivatives thereof).

In some embodiments, the flavonoid compound is a bioflavonoid. In some embodiments, the flavonoid compound is a flavanone, such as hydroxyl-, methoxy-, and/or glycoside-substituted derivatives of flavanone. In some embodiments, the flavonoid compound is blumeatin, butin, eriodictyol, hesperetin, hesperidin, homoeriodictyol, isosakuranetin, naringenin, naringin, pinocembrin, poncirin, sakuranetin, sakuranin, sterubin, pinostrobin, or a combination thereof. In some embodiments, the flavonoid compound is naringenin. In some embodiments, the flavonoid compound is hesperetin. In some embodiments, the flavonoid compound is naringenin, hesperetin, or a combination thereof.

In some other embodiments, the flavonoid compound is an isoflavonoid, such as an isoflavone, an isoflavonone, an isoflavan, a pterocarpan, a rotenoid, or any combination thereof.

In some embodiments, the flavonoid compound is a neoflavonoid, such as a neoflavone, a neoflavene, or any combinations thereof. Examples of neoflavonoids include coutareagenin, dalbergin, and nivetin.

In some embodiments, the flavonoid compound is a dihydrochalcone. In some such embodiments, the flavonoid compound is aspalathin, naringin hyhydrochalcone, neohesperedin dihydrochalcone, nothofagin, phloretin, or any combination thereof. In some embodiments, the flavonoid compound is phloretin.

In some embodiments, the flavonoid compound is rhoifolin, neodiosmin, phloretin, hesperetin, naringenin, hesperetin dihydrochalcone, diosmin, neohesperidine dihydrochalcone, diosmetin, trilobatin dihydrochalcone, naringin dihydrochalcone, or any combinations thereof. In some embodiments, the flavonoid compound is naringenin, hesperetin, phloretin, rhoifolin, or any combination thereof. In some embodiments, the flavonoid compound is naringenin, phloretin, or any combination thereof.

### Anthocyanin Compounds

In various embodiments of the uses, methods, and compositions provided herein, one or more anthocyanin compounds are employed. As used herein the term “anthocyanin compounds” refers to members of a class of water-soluble natural pigments. In some embodiments, the anthocyanin compounds are comprised by a plant extract, such as an extract of one or more plants selected from the group consisting of blueberry, bilberry, cranberry, lingonberry, blackberry, black raspberry, red raspberry, blackcurrant, cherry, eggplant, black rice, black corn, black soybean, ube, Okinawan sweet potato, red cabbage, violet, peach, apple, and any combinations thereof.

In some embodiments, the one or more anthocyanin compounds are compounds of formula (I):

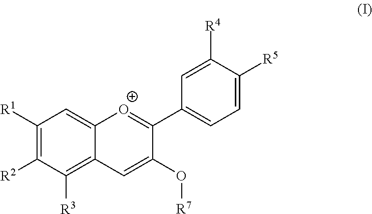

wherein: R¹, R², R³, R⁴, R⁵, and R⁶ are each independently —H, —OH, or —OCH₃; and R⁷ is —H or a glucosyl moiety.

In some embodiments, R¹ is —OH or —OCH₃. In some embodiments, R¹ is —OH. In some embodiments, R¹ is —OCH₃.

In some embodiments of any of the preceding embodiments, R³ is —OH or —OCH₃. In some further such embodiments, R³ is —OH. In some further such embodiments, R³ is —OCH₃.

In some embodiments of any of the preceding embodiments, R² is —OH or —H. In some further such embodiments, R² is —OH. In some further such embodiments, R² is —H.

In some embodiments of any of the preceding embodiments, R⁵ is —OH or —OCH₃. In some further such embodiments, R⁵ is —OH. In some further such embodiments, R⁵ is —OCH₃.

In some embodiments of any of the preceding embodiments, R⁴ is —OH. In some embodiments of any of the preceding embodiments, R⁴ is —H. In some embodiments of any of the preceding embodiments, R⁴ is —OCH₃.

In some embodiments of any of the preceding embodiments, R⁶ is —OH. In some embodiments of any of the preceding embodiments, R⁶ is —H. In some embodiments of any of the preceding embodiments, R⁶ is —OCH₃.

In some embodiments of any of the preceding embodiments, R⁷ is —H. In some embodiments of any of the preceding embodiments, R⁷ is a glucosyl moiety. Such glucosyl moieties can connect through any suitable position.

Note that compounds in which R⁷ is —H can also be referred to as anthocyanidins. As used herein, the term “anthocyanin” includes such compounds.

In some embodiments, the one or more anthocyanin compounds comprise cyanidin, pelargonidin, peonidin, rosinidin, delphinidin, petuninid, malvidin, or any combinations thereof. In some embodiments, the one or more anthocyanin compounds comprise cyanidin. In some embodiments, the one or more anthocyanin compounds comprise delphinidin.

In some embodiments, the one or more anthocyanin compounds have a pKa of no higher than 5.0, or no higher than 4.5, or no higher than 4.0, or no higher than 3.5, or no higher than 3.0.

### Saponins

The terms “saponin” or “saponin compound” refer to natural amphipathic glycoside compounds having a hydrophobic portion, which is formed from a sapogenin (such as a triterpene or a steroid), and a hydrophilic portion formed from a chain of one or more glycoside units (such as D-glucose or D-galactose units). Saponins are present in diverse plant extracts. As “natural extract comprising saponins” it is meant here any saponin or mixture of substances comprising saponins obtained by applying a physical separation process to a raw material that is available in nature. Preferred natural extracts are those comprising at least 10% by weight, more preferably at least 20% by weight, even more preferably at least 50% by weight, most preferably at least 80% by weight, relative to the total weight of the extract, of saponins, As preferred examples of natural extracts that can be used in the present invention, one can cite plant extracts, such as quillaja extract, camellia seeds extract, achyranthe extract, glycyrrhizine and stevia. Quillaja extract, which is obtained from the bark of Quillaja saponaria is particularly appreciated for the purpose of the present invention. Such plant extracts are commercially available from diverse suppliers.

In some embodiments, the saponins used herein have a hydrophilic-lipophilic balance (HLB), as measured by Griffin's method, of greater than 10, or no less than 11, or no less than 12. In some embodiments, the saponins used herein are soluble in water at the concentrations employed.

### Aqueous Compositions Comprising Flavonoid

In various embodiments of the uses, methods, and compositions provided herein, one or more compounds, which are anthocyanin compounds, saponin compounds, or any combination thereof, are introduced in combination with a flavonoid compound to an aqueous composition (or medium). In this context, the term “introduce,” in its various grammatical forms, means that the compounds are made to be present together in the aqueous composition. No particular order or manner of their introduction to the aqueous composition is intended or implied.

In some embodiments, anthocyanin compounds are introduced into the aqueous composition. In such embodiments, the anthocyanin compounds can have any suitable ratio to the flavonoid compounds in the aqueous composition. For example, in some embodiments, the molar ratio of the one or more anthocyanins to the flavonoid in the aqueous medium ranges from 1:50 to 50:1, 1:50 to 10:1, or from 1:50 to 5:1, or from 1:20 to 5:1, or from 1:10 to 5:1, or from 1:5 to 5:1, or from 1:50 to 4:1, or from 1:20 to 4:1, or from 1:10 to 4:1, or from 1:5 to 4:1, or from 1:50 to 3:1, or from 1:20 to 3:1, or from 1:10 to 3:1, or from 1:5 to 3:1, or from 1:50 to 2:1, or from 1:20 to 2:1, or from 1:10 to 2:1, or from 1:5 to 2:1.

The anthocyanins can be present in the aqueous composition at any suitable concentration. For example, in some embodiments, the concentration of the one or more anthocyanins in the aqueous medium ranges from 1 ppm to 1000 ppm, or from 1 ppm to 500 ppm, or from 1 ppm to 300 ppm, or from 1 ppm to 200 ppm, or from 1 ppm to 100 ppm, or from 5 ppm to 300 ppm, or from 5 ppm to 200 ppm, or from 5 ppm to 100 ppm, or from 10 ppm to 300 ppm, or from 10 ppm to 200 ppm, or from 10 ppm to 100 ppm, or from 25 ppm to 300 ppm, or from 25 ppm to 200 ppm, or from 25 ppm to 100 ppm, or from 45 ppm to 300 ppm, or from 45 ppm to 200 ppm, or from 45 ppm to 100 ppm, or from 50 ppm to 300 ppm, or from 50 ppm to 200 ppm, or from 50 ppm to 100 ppm.

In some embodiments, saponin compounds are introduced to the aqueous composition. The saponins can be present in the aqueous composition at any suitable concentration. For example, in some embodiments, the one or more saponins in the aqueous medium ranges from 1 ppm to 1000 ppm, or from 1 ppm to 500 ppm, or from 1 ppm to 300 ppm, or from 5 ppm to 100 ppm, or from 5 ppm to 50 ppm.

In such embodiments, where saponins are present in the composition, the saponin compounds can have any suitable ratio to the flavonoid compounds in the aqueous composition. For example, in some embodiments, the molar ratio of the one or more saponins to the flavonoid in the aqueous medium ranges from 1:50 to 50:1, 1:50 to 10:1, or from 1:50 to 5:1, or from 1:20 to 5:1, or from 1:10 to 5:1, or from 1:5 to 5:1, or from 1:50 to 4:1, or from 1:20 to 4:1, or from 1:10 to 4:1, or from 1:5 to 4:1, or from 1:50 to 3:1, or from 1:20 to 3:1, or from 1:10 to 3:1, or from 1:5 to 3:1, or from 1:50 to 2:1, or from 1:20 to 2:1, or from 1:10 to 2:1, or from 1:5 to 2:1.

The flavonoid compound can also be present at any suitable concentration. In some embodiments, the flavonoid compound is solvated in the aqueous composition at a concentration greater than its solubility in distilled water at the same temperature and pressure, meaning that it is a supersaturated solution of the flavonoid. One may refer to it concentration as a percentage greater than its saturated concentration. In some embodiments, the flavonoid compound is present in the aqueous composition at a concentration that ranges from 10% to 1000% greater, or from 25% to 500% greater, or from 50% to 200% greater than its saturated concentration. In some embodiments, the flavonoid in the aqueous medium ranges from 1 ppm to 1000 ppm, or from 1 ppm to 500 ppm, or from 1 ppm to 300 ppm, or from 5 ppm to 100 ppm, or from 25 ppm to 300 ppm, or from 25 ppm to 200 ppm, or from 25 ppm to 100 ppm, or from 45 ppm to 300 ppm, or from 45 ppm to 200 ppm, or from 45 ppm to 100 ppm, or from 50 ppm to 300 ppm, or from 50 ppm to 200 ppm, or from 50 ppm to 100 ppm.

In some instances, the aqueous composition (or medium) can be described in terms of the absence (or a low maximum concentration) of certain compounds. This is particularly true of certain compounds that may have an adverse effect on taste, such as surfactants, co-solvents, hydrotropes, and complexing agents. For example, in some embodiments of any of the preceding embodiments, the aqueous medium is substantially free of surfactants, e.g., comprises surfactants at a concentration of no more than 1000 ppm, or no more than 500 ppm, or no more than 250 ppm, or no more than 100 ppm, or no more than 50 ppm, or no more than 30 ppm, or no more than 20 ppm, or no more than 10 ppm, or no more than 5 ppm. In some other embodiments of any of the preceding embodiments, the aqueous medium has a low concentration of co-solvents, e.g., comprises co-solvents at a concentration of no more than 5000 ppm, or no more than 3000 ppm, or no more than 2000 ppm, or no more than 1000 ppm, or no more than 500 ppm, or no more than 250 ppm, or no more than 100 ppm, or no more than 50 ppm, or no more than 30 ppm, or no more than 20 ppm, or no more than 10 ppm, or no more than 5 ppm. In some other embodiments of any of the preceding embodiments, the aqueous medium is substantially free of hydrotropes, e.g., comprises hydrotropes at a concentration of no more than 1000 ppm, or no more than 500 ppm, or no more than 250 ppm, or no more than 100 ppm, or no more than 50 ppm, or no more than 30 ppm, or no more than 20 ppm, or no more than 10 ppm, or no more than 5 ppm. In some other embodiments of any of the preceding embodiments, the aqueous medium is substantially free of complexing agents, e.g., comprises complexing agents at a concentration of no more than 1000 ppm, or no more than 500 ppm, or no more than 250 ppm, or no more than 100 ppm, or no more than 50 ppm, or no more than 30 ppm, or no more than 20 ppm, or no more than 10 ppm, or no more than 5 ppm.

In certain embodiments of any aspects and embodiments set forth herein that refer to an aqueous composition, the aqueous composition is a non-naturally-occurring composition, such as a beverage or a composition specifically manufactured for the production of a beverage product.

In certain aspects and embodiments, the disclosure provides comestible compositions comprising: an aqueous carrier (according to any of the embodiments set forth in this section), which comprises at least 50% by weight water; a flavonoid compound, which is at least partially solvated by the aqueous carrier; and one or more anthocyanin compounds. In some embodiments, the flavonoid compound is at least partially solvated by the aqueous carrier at a concentration greater than the saturation concentration of the flavonoid compound in water (for example, at 25° C. and 100 kPa).

The aqueous composition (or medium) can take the form of various products. For example, in some embodiments, the aqueous medium is a dairy product, such as yogurt, dairy-based beverages, condensed milk, dairy-based protein drinks, dairy-based meal-replacement drinks, and the like, or a substitute dairy product, such as coconut milk, almond milk, soy milk, cashew milk, rice milk, oat milk, non-dairy-based protein drinks, non-dairy-based meal-replacement drinks, and the like. In some other embodiments, the aqueous medium is a beverage product, such as soda, energy drinks, kombucha, hard seltzer, and the like. In some other embodiments, the aqueous medium is a flavoring concentrate, such as a flavoring concentrate suitable for adding to compositions comprising water, soda, alcohol, or combinations thereof.

In some embodiments, aqueous media disclosed herein can impart a more sugar-like temporal profile or flavor profile to a sweetener composition by combining the composition as disclosed and described herein with one or more sweeteners in the sweetener composition. In some embodiments, aqueous media as disclosed herein can increase or enhance the sweet taste of a composition by contacting the composition thereof with the composition as disclosed and described herein to form a modified composition.

Thus, in some embodiments, the aqueous media set forth in any of the foregoing aspects and embodiments, can also comprise a sweetener. For example, in some embodiments, the sweetener is present in an amount from about 0.1% to about 12% by weight. In some embodiments, the sweetener is present in an amount from about 0.2% to about 10% by weight. In some embodiments, the sweetener is present in an amount from about 0.3% to about 8% by weight. In some embodiments, the sweetener is present in an amount from about 0.4% to about 6% by weight. In some embodiments, the sweetener is present in an amount from about 0.5% to about 5% by weight. In some embodiments, the sweetener is present in an amount from about 1% to about 2% by weight. In some embodiments, the sweetener is present in an amount from about 0.1% to about 5% by weight. In some embodiments, the sweetener is present in an amount from about 0.1% to about 4% by weight. In some embodiments, the sweetener is present in an amount from about 0.1% to about 3% by weight. In some embodiments, the sweetener is present in an amount from about 0.1% to about 2% by weight. In some embodiments, the sweetener is present in an amount from about 0.1% to about 1% by weight. In some embodiments, the sweetener is present in an amount from about 0.1% to about 0.5% by weight. In some embodiments, the sweetener is present in an amount from about 0.5% to about 10% by weight. In some embodiments, the sweetener is present in an amount from about 2% to about 8% by weight. In some further embodiments of the embodiments set forth in this paragraph, the sweetener is sucrose, fructose, glucose, xylitol, erythritol, or combinations thereof.

In some other embodiments, the sweetener is present in an amount from 10 ppm to 1000 ppm. In some embodiments, the sweetener is present in an amount from 20 ppm to 800 ppm. In some embodiments, the sweetener is present in an amount from 30 ppm to 600 ppm. In some embodiments, the sweetener is present in an amount from 40 ppm to 500 ppm. In some embodiments, the sweetener is present in an amount from 50 ppm to 400 ppm. In some embodiments, the sweetener is present in an amount from 50 ppm to 300 ppm. In some embodiments, the sweetener is present in an amount from 50 ppm to 200 ppm. In some embodiments, the sweetener is present in an amount from 50 ppm to 150 ppm. In some further embodiments of the embodiments set forth in this paragraph, the sweetener is a steviol glycoside, a mogroside, a derivative of either of the foregoing, such as glycoside derivatives (e.g., glucosylates), or any combination thereof.

The aqueous media can include any suitable sweeteners or combination of sweeteners. In some embodiments, the sweetener is a common saccharide sweeteners, such as sucrose, fructose, glucose, and sweetener compositions comprising natural sugars, such as corn syrup (including high fructose corn syrup) or other syrups or sweetener concentrates derived from natural fruit and vegetable sources. In some embodiments, the sweetener is sucrose, fructose, or a combination thereof. In some embodiments, the sweetener is sucrose. In some other embodiments, the sweetener is selected from rare natural sugars including D-allose, D-psicose, L-ribose, D-tagatose, L-glucose, L-fucose, L-arbinose, D-turanose, and D-leucrose. In some embodiments, the sweetener is selected from semi-synthetic “sugar alcohol” sweeteners such as erythritol, isomalt, lactitol, mannitol, sorbitol, xylitol, maltodextrin, and the like. In some embodiments, the sweetener is selected from artificial sweeteners such as aspartame, saccharin, acesulfame-K, cyclamate, sucralose, and alitame. In some embodiments, the sweetener is selected from the group consisting of cyclamic acid, mogroside, tagatose, maltose, galactose, mannose, sucrose, fructose, lactose, neotame and other aspartame derivatives, glucose, D-tryptophan, glycine, maltitol, lactitol, isomalt, hydrogenated glucose syrup (HGS), hydrogenated starch hydrolyzate (HSH), stevioside, rebaudioside A, other sweet Stevia-based glycosides, chemically modified steviol glycosides (such as glucosylated steviol glycosides), mogrosides, chemically modified mogrosides (such as glucosylated mogrosides), carrelame and other guanidine-based sweeteners. In some embodiments, the sweetener is a combination of two or more of the sweeteners set forth in this paragraph. In some embodiments, the sweetener may combinations of two, three, four or five sweeteners as disclosed herein. In some embodiments, the sweetener may be a sugar. In some embodiments, the sweetener may be a combination of one or more sugars and other natural and artificial sweeteners. In some embodiments, the sweetener is a sugar. In some embodiments, the sugar is cane sugar. In some embodiments, the sugar is beet sugar. In some embodiments, the sugar may be sucrose, fructose, glucose or combinations thereof. In some embodiments, the sugar may be sucrose. In some embodiments, the sugar may be a combination of fructose and glucose.

The sweetener can also include, for example, sweetener compositions comprising one or more natural or synthetic carbohydrate, such as corn syrup, high fructose corn syrup, high maltose corn syrup, glucose syrup, sucralose syrup, hydrogenated glucose syrup (HGS), hydrogenated starch hydrolyzate (HSH), or other syrups or sweetener concentrates derived from natural fruit and vegetable sources, or semi-synthetic “sugar alcohol” sweeteners such as polyols. Non-limiting examples of polyols in some embodiments include erythritol, maltitol, mannitol, sorbitol, lactitol, xylitol, isomalt, propylene glycol, glycerol (glycerin), threitol, galactitol, palatinose, reduced isomalto-oligosaccharides, reduced xylo-oligosaccharides, reduced gentio-oligosaccharides, reduced maltose syrup, reduced glucose syrup, isomaltulose, maltodextrin, and the like, and sugar alcohols or any other carbohydrates or combinations thereof capable of being reduced which do not adversely affect taste.

The sweetener may be a natural or synthetic sweetener that includes, but is not limited to, agave inulin, agave nectar, agave syrup, amazake, brazzein, brown rice syrup, coconut crystals, coconut sugars, coconut syrup, date sugar, fructans (also referred to as inulin fiber, fructo-oligosaccharides, or oligo-fructose), green stevia powder, Stevia rebaudiana, rebaudioside A, rebaudioside B, rebaudioside C, rebaudioside D, rebaudioside E, rebaudioside F, rebaudioside I, rebaudioside H, rebaudioside L, rebaudioside K, rebaudioside J, rebaudioside N, rebaudioside 0, rebaudioside M and other sweet stevia-based glycosides, stevioside, stevioside extracts, honey, Jerusalem artichoke syrup, licorice root, luo han guo (fruit, powder, or extracts), lucuma (fruit, powder, or extracts), maple sap (including, for example, sap extracted from Acer saccharum, Acer nigrum, Acer rubrum, Acer saccharinum, Acer platanoides, Acer negundo, Acer macrophyllum, Acer grandidentatum, Acer glabrum, Acer mono), maple syrup, maple sugar, walnut sap (including, for example, sap extracted from Juglans cinerea, Juglans nigra, Juglans ailatifolia, Juglans regia), birch sap (including, for example, sap extracted from Betula papyrifera, Betula alleghaniensis, Betula lenta, Betula nigra, Betula populifolia, Betula pendula), sycamore sap (such as, for example, sap extracted from Platanus occidentalis), ironwood sap (such as, for example, sap extracted from Ostrya virginiana), mascobado, molasses (such as, for example, blackstrap molasses), molasses sugar, monatin, monellin, cane sugar (also referred to as natural sugar, unrefined cane sugar, or sucrose), palm sugar, panocha, piloncillo, rapadura, raw sugar, rice syrup, sorghum, sorghum syrup, cassava syrup (also referred to as tapioca syrup), thaumatin, yacon root, malt syrup, barley malt syrup, barley malt powder, beet sugar, cane sugar, crystalline juice crystals, caramel, carbitol, carob syrup, castor sugar, hydrogenated starch hydrolates, hydrolyzed can juice, hydrolyzed starch, invert sugar, anethole, arabinogalactan, arrope, syrup, P-4000, acesulfame potassium (also referred to as acesulfame K or ace-K), alitame (also referred to as aclame), advantame, aspartame, baiyunoside, neotame, benzamide derivatives, bernadame, canderel, carrelame and other guanidine-based sweeteners, vegetable fiber, corn sugar, coupling sugars, curculin, cyclamates, cyclocarioside I, demerara, dextran, dextrin, diastatic malt, dulcin, sucrol, valzin, dulcoside A, dulcoside B, emulin, enoxolone, maltodextrin, saccharin, estragole, ethyl maltol, glucin, gluconic acid, glucono-lactone, glucosamine, glucoronic acid, glycerol, glycine, glycyphillin, glycyrrhizin, glycyrrhetic acid monoglucuronide, golden sugar, yellow sugar, golden syrup, granulated sugar, gynostemma, hernandulcin, isomerized liquid sugars, jallab, chicory root dietary fiber, kynurenine derivatives (including N′-formyl-kynurenine, N′-acetyl-kynurenine, 6-chloro-kynurenine), galactitol, litesse, ligicane, lycasin, lugduname, guanidine, falernum, mabinlin I, mabinlin II, maltol, maltisorb, maltodextrin, maltotriol, mannosamine, miraculin, mizuame, mogrosides (including, for example, mogroside IV, mogroside V, and neomogroside), mukurozioside, nano sugar, naringin dihydrochalcone, neohesperidine dihydrochalcone, nib sugar, nigero-oligosaccharide, norbu, orgeat syrup, osladin, pekmez, pentadin, periandrin I, perillaldehyde, perillartine, petphyllum, phenylalanine, phlomisoside I, phlorodizin, phyllodulcin, polyglycitol syrups, polypodoside A, pterocaryoside A, pterocaryoside B, rebiana, refiners syrup, rub syrup, rubusoside, selligueain A, siamenoside I, siraitia grosvenorii, soybean oligosaccharide, Splenda, SRI oxime V, steviol glycoside, steviolbioside, stevioside, strogins 1, 2, and 4, sucronic acid, sucrononate, sugar, suosan, phloridzin, superaspartame, tetrasaccharide, threitol, treacle, trilobatin, D-tryptophan and derivatives (6-trifluoromethyl-tryptophan, 6-chloro-D-tryptophan), vanilla sugar, volemitol, birch syrup, aspartame-acesulfame, assugrin, aromedendrin-3-O-acetate, dihydrotamarixetin-3-O-acetate, and combinations or blends of any two or more thereof.

In still other embodiments, the sweetener can be a chemically or enzymatically modified natural high potency sweetener. Modified natural high potency sweeteners include glycosylated natural high potency sweetener such as glucosyl-, galactosyl-, or fructosyl-derivatives containing 1-50 glycosidic residues. Glycosylated natural high potency sweeteners may be prepared by enzymatic transglycosylation reaction catalyzed by various enzymes possessing transglycosylating activity. In some embodiments, the modified sweetener can be substituted or unsubstituted.

Additional sweeteners also include combinations of any two or more of any of the aforementioned sweeteners. In some embodiments, the sweetener may comprise combinations of two, three, four or five sweeteners as disclosed herein. In some embodiments, the sweetener may be a sugar. In some embodiments, the sweetener may be a combination of one or more sugars and other natural and artificial sweeteners. In some embodiments, the sweetener is a caloric sweetener, such as sucrose, fructose, xylitol, erythritol, or combinations thereof. In some embodiments, the ingestible compositions are free (or, in some embodiments) substantially free of stevia-derived sweeteners, such as steviol glycosides, glucosylated steviol glycosides, or rebaudiosides. For example, in some embodiments, the ingestible compositions are either free of stevia-derived sweeteners or comprise stevia-derived sweeteners in a concentration of no more than 1000 ppm, or no more than 500 ppm, or no more than 200 ppm, or no more than 100 ppm, or no more than 50 ppm, or no more than 20 ppm, or no more than 10 ppm, or no more than 5 ppm, or no more than 3 ppm, or no more than 1 ppm.

The aqueous media, in certain embodiments, also comprise any additional ingredients or combination of ingredients as are commonly used in food and beverage products, including, but not limited to:

acids, including, for example citric acid, phosphoric acid, ascorbic acid, sodium acid sulfate, lactic acid, or tartaric acid;

bitter ingredients, including, for example caffeine, quinine, green tea, catechins, polyphenols, green robusta coffee extract, green coffee extract, potassium chloride, menthol, or proteins (such as proteins and protein isolates derived from plants, algae, or fungi);

coloring agents, including, for example caramel color, Red #40, Yellow #5, Yellow #6, Blue #1, Red #3, purple carrot, black carrot juice, purple sweet potato, vegetable juice, fruit juice, beta carotene, turmeric curcumin, or titanium dioxide;

preservatives, including, for example sodium benzoate, potassium benzoate, potassium sorbate, sodium metabisulfate, sorbic acid, or benzoic acid;

antioxidants including, for example ascorbic acid, calcium disodium EDTA, alpha tocopherols, mixed tocopherols, rosemary extract, grape seed extract, resveratrol, or sodium hexametaphosphate;

vitamins or functional ingredients including, for example resveratrol, Co-Q10, omega 3 fatty acids, theanine, choline chloride (citocoline), fibersol, inulin (chicory root), taurine, panax ginseng extract, guanana extract, ginger extract, L-phenylalanine, L-carnitine, L-tartrate, D-glucoronolactone, inositol, bioflavonoids, Echinacea, ginko biloba, yerba mate, flax seed oil, garcinia cambogia rind extract, white tea extract, ribose, milk thistle extract, grape seed extract, pyrodixine HCl (vitamin B6), cyanoobalamin (vitamin B12), niacinamide (vitamin B3), biotin, calcium lactate, calcium pantothenate (pantothenic acid), calcium phosphate, calcium carbonate, chromium chloride, chromium polynicotinate, cupric sulfate, folic acid, ferric pyrophosphate, iron, magnesium lactate, magnesium carbonate, magnesium sulfate, monopotassium phosphate, monosodium phosphate, phosphorus, potassium iodide, potassium phosphate, riboflavin, sodium sulfate, sodium gluconate, sodium polyphosphate, sodium bicarbonate, thiamine mononitrate, vitamin D3, vitamin A palmitate, zinc gluconate, zinc lactate, or zinc sulphate;

clouding agents, including, for example ester gum, brominated vegetable oil (BVO), or sucrose acetate isobutyrate (SAIB);

buffers, including, for example sodium citrate, potassium citrate, or salt;

flavors, including, for example propylene glycol, ethyl alcohol, glycerine, gum Arabic (gum acacia), maltodextrin, modified corn starch, dextrose, natural flavor, natural flavor with other natural flavors (natural flavor WONF), natural and artificial flavors, artificial flavor, silicon dioxide, magnesium carbonate, or tricalcium phosphate; or

starches and stabilizers, including, for example pectin, xanthan gum, carboxylmethylcellulose (CMC), polysorbate 20, polysorbate 60, polysorbate 80, medium chain triglycerides, cellulose gel, cellulose gum, sodium caseinate, modified food starch, sucrose esters, gum Arabic (gum acacia), inulin, or carrageenan.

The aqueous media can have any suitable pH. In some embodiments, the flavonoid compounds enhance the sweetness of a sweetener under a broad range of pH, e.g., from lower pH to neutral pH. The lower and neutral pH includes, but is not limited to, a pH from about 2.5 to about 8.5; from about 3.0 to about 8.0; from about 3.5 to about 7.5; and from about 4.0 to about 7. In certain embodiments, the flavonoids as disclosed and described herein, individually or in combination, can enhance the perceived sweetness of a fixed concentration of a sweetener in taste tests at a compound concentration of about 50 μM, 40 μM, 30 μM, 20 μM, or 10 μM at both low to neutral pH value. In certain embodiments, the enhancement factor of the flavonoids as disclosed and described herein, individually or in combination, at the lower pH is substantially similar to the enhancement factor of the compounds at neutral pH. Such consistent sweet enhancing property under a broad range of pH allow a broad use in a wide variety of foods and beverages of the compounds as disclosed and described herein, individually or in combination.

The aqueous media set forth according to any of the foregoing embodiments, also include, in certain embodiments, one or more additional flavor-modifying compounds, such as compounds that enhance sweetness (e.g., glucosylated steviol glycosides, etc.), compounds that block bitterness, compounds that enhance umami, compounds that reduce sourness or licorice taste, compounds that enhance saltiness, compounds that enhance a cooling effect, or any combinations of the foregoing.

Compounds that reduce or mask astringency (such as the phloretin) can also be included at suitable concentrations, such as concentrations ranging from 1 ppm to 200 ppm, or from 1 ppm to 100 ppm, or from 1 ppm to 50 ppm, or from 1 ppm to 25 ppm, or from 1 ppm to 20 ppm, or from 1 ppm to 10 ppm.

### Flavored Products and Concentrates

In certain aspects, the aqueous media disclosed herein are flavored products or concentrates. In some embodiments, the flavored products are beverage products, such as soda, flavored water, tea, and the like. In some other embodiments, the flavored products are food products, such as yogurt.

In embodiments where the flavored product is a beverage, the beverage may be selected from the group consisting of enhanced sparkling beverages, colas, lemon-lime flavored sparkling beverages, orange flavored sparkling beverages, grape flavored sparkling beverages, strawberry flavored sparkling beverages, pineapple flavored sparkling beverages, ginger-ales, root beers, fruit juices, fruit-flavored juices, juice drinks, nectars, vegetable juices, vegetable-flavored juices, sports drinks, energy drinks, enhanced water drinks, enhanced water with vitamins, near water drinks, coconut waters, tea type drinks, coffees, cocoa drinks, beverages containing milk components, beverages containing cereal extracts and smoothies. In some embodiments, the beverage may be a soft drink.

In certain embodiments of any aspects and embodiments set forth herein that refer to an flavored product, the flavored product is a non-naturally-occurring product, such as a packaged food or beverage product.

Further non-limiting examples of food and beverage products or formulations include sweet coatings, frostings, or glazes for such products or any entity included in the Soup category, the Dried Processed Food category, the Beverage category, the Ready Meal category, the Canned or Preserved Food category, the Frozen Processed Food category, the Chilled Processed Food category, the Snack Food category, the Baked Goods category, the Confectionery category, the Dairy Product category, the Ice Cream category, the Meal Replacement category, the Pasta and Noodle category, and the Sauces, Dressings, Condiments category, the Baby Food category, and/or the Spreads category.

In general, the Soup category refers to canned/preserved, dehydrated, instant, chilled, UHT and frozen soup. For the purpose of this definition soup(s) means a food prepared from meat, poultry, fish, vegetables, grains, fruit and other ingredients, cooked in a liquid which may include visible pieces of some or all of these ingredients. It may be clear (as a broth) or thick (as a chowder), smooth, pureed or chunky, ready-to-serve, semi-condensed or condensed and may be served hot or cold, as a first course or as the main course of a meal or as a between meal snack (sipped like a beverage). Soup may be used as an ingredient for preparing other meal components and may range from broths (consommé) to sauces (cream or cheese-based soups).

The Dehydrated and Culinary Food Category usually means: (i) Cooking aid products such as: powders, granules, pastes, concentrated liquid products, including concentrated bouillon, bouillon and bouillon like products in pressed cubes, tablets or powder or granulated form, which are sold separately as a finished product or as an ingredient within a product, sauces and recipe mixes (regardless of technology); (ii) Meal solutions products such as: dehydrated and freeze dried soups, including dehydrated soup mixes, dehydrated instant soups, dehydrated ready-to-cook soups, dehydrated or ambient preparations of ready-made dishes, meals and single serve entrees including pasta, potato and rice dishes; and (iii) Meal embellishment products such as: condiments, marinades, salad dressings, salad toppings, dips, breading, batter mixes, shelf stable spreads, barbecue sauces, liquid recipe mixes, concentrates, sauces or sauce mixes, including recipe mixes for salad, sold as a finished product or as an ingredient within a product, whether dehydrated, liquid or frozen.

The Beverage category usually means beverages, beverage mixes and concentrates, including but not limited to, carbonated and non-carbonated beverages, alcoholic and non-alcoholic beverages, ready to drink beverages, liquid concentrate formulations for preparing beverages such as sodas, and dry powdered beverage precursor mixes. The Beverage category also includes the alcoholic drinks, the soft drinks, sports drinks, isotonic beverages, and hot drinks. The alcoholic drinks include, but are not limited to beer, cider/perry, FABs, wine, and spirits. The soft drinks include, but are not limited to carbonates, such as colas and non-cola carbonates; fruit juice, such as juice, nectars, juice drinks and fruit flavored drinks; bottled water, which includes sparkling water, spring water and purified/table water; functional drinks, which can be carbonated or still and include sport, energy or elixir drinks; concentrates, such as liquid and powder concentrates in ready to drink measure. The drinks, either hot or cold, include, but are not limited to coffee or ice coffee, such as fresh, instant, and combined coffee; tea or ice tea, such as black, green, white, oolong, and flavored tea; and other drinks including flavor-, malt- or plant-based powders, granules, blocks or tablets mixed with milk or water.

The Snack Food category generally refers to any food that can be a light informal meal including, but not limited to Sweet and savory snacks and snack bars. Examples of snack food include, but are not limited to fruit snacks, chips/crisps, extruded snacks, tortilla/corn chips, popcorn, pretzels, nuts and other sweet and savory snacks. Examples of snack bars include, but are not limited to granola/muesli bars, breakfast bars, energy bars, fruit bars and other snack bars.

The Baked Goods category generally refers to any edible product the process of preparing which involves exposure to heat or excessive sunlight. Examples of baked goods include, but are not limited to bread, buns, cookies, muffins, cereal, toaster pastries, pastries, waffles, tortillas, biscuits, pies, bagels, tarts, quiches, cake, any baked foods, and any combination thereof.

The Ice Cream category generally refers to frozen dessert containing cream and sugar and flavoring. Examples of ice cream include, but are not limited to: impulse ice cream; take-home ice cream; frozen yoghurt and artisanal ice cream; soy, oat, bean (e.g., red bean and mung bean), and rice-based ice creams.

The Confectionery category generally refers to edible product that is sweet to the taste. Examples of confectionery include, but are not limited to candies, gelatins, chocolate confectionery, sugar confectionery, gum, and the likes and any combination products.

The Meal Replacement category generally refers to any food intended to replace the normal meals, particularly for people having health or fitness concerns. Examples of meal replacement include, but are not limited to slimming products and convalescence products.

The Ready Meal category generally refers to any food that can be served as meal without extensive preparation or processing. The ready meal includes products that have had recipe “skills” added to them by the manufacturer, resulting in a high degree of readiness, completion and convenience. Examples of ready meal include, but are not limited to canned/preserved, frozen, dried, chilled ready meals; dinner mixes; frozen pizza; chilled pizza; and prepared salads.

The Pasta and Noodle category includes any pastas and/or noodles including, but not limited to canned, dried and chilled/fresh pasta; and plain, instant, chilled, frozen and snack noodles.

The Canned/Preserved Food category includes, but is not limited to canned/preserved meat and meat products, fish/seafood, vegetables, tomatoes, beans, fruit, ready meals, soup, pasta, and other canned/preserved foods.

The Frozen Processed Food category includes, but is not limited to frozen processed red meat, processed poultry, processed fish/seafood, processed vegetables, meat substitutes, processed potatoes, bakery products, desserts, ready meals, pizza, soup, noodles, and other frozen food.

The Dried Processed Food category includes, but is not limited to rice, dessert mixes, dried ready meals, dehydrated soup, instant soup, dried pasta, plain noodles, and instant noodles. The Chill Processed Food category includes, but is not limited to chilled processed meats, processed fish/seafood products, lunch kits, fresh cut fruits, ready meals, pizza, prepared salads, soup, fresh pasta and noodles.

The Sauces, Dressings and Condiments category includes, but is not limited to tomato pastes and purees, bouillon/stock cubes, herbs and spices, monosodium glutamate (MSG), table sauces, soy based sauces, pasta sauces, wet/cooking sauces, dry sauces/powder mixes, ketchup, mayonnaise, mustard, salad dressings, vinaigrettes, dips, pickled products, and other sauces, dressings and condiments.

The Baby Food category includes, but is not limited to milk- or soybean-based formula; and prepared, dried and other baby food.

The Spreads category includes, but is not limited to jams and preserves, honey, chocolate spreads, nut based spreads, and yeast based spreads.

The Dairy Product category generally refers to edible product produced from mammal's milk. Examples of dairy product include, but are not limited to drinking milk products, cheese, yoghurt and sour milk drinks, and other dairy products.

Additional examples for flavored products, particularly food and beverage products or formulations, are provided as follows. Exemplary ingestible compositions include one or more confectioneries, chocolate confectionery, tablets, countlines, bagged selflines/softlines, boxed assortments, standard boxed assortments, twist wrapped miniatures, seasonal chocolate, chocolate with toys, alfajores, other chocolate confectionery, mints, standard mints, power mints, boiled sweets, pastilles, gums, jellies and chews, toffees, caramels and nougat, medicated confectionery, lollipops, liquorice, other sugar confectionery, bread, packaged/industrial bread, unpackaged/artisanal bread, pastries, cakes, packaged/industrial cakes, unpackaged/artisanal cakes, cookies, chocolate coated biscuits, sandwich biscuits, filled biscuits, savory biscuits and crackers, bread substitutes, breakfast cereals, rte cereals, family breakfast cereals, flakes, muesli, other cereals, children's breakfast cereals, hot cereals, ice cream, impulse ice cream, single portion dairy ice cream, single portion water ice cream, multi-pack dairy ice cream, multi-pack water ice cream, take-home ice cream, take-home dairy ice cream, ice cream desserts, bulk ice cream, take-home water ice cream, frozen yoghurt, artisanal ice cream, dairy products, milk, fresh/pasteurized milk, full fat fresh/pasteurized milk, semi skimmed fresh/pasteurized milk, long-life/uht milk, full fat long life/uht milk, semi skimmed long life/uht milk, fat-free long life/uht milk, goat milk, condensed/evaporated milk, plain condensed/evaporated milk, flavored, functional and other condensed milk, flavored milk drinks, dairy only flavored milk drinks, flavored milk drinks with fruit juice, soy milk, sour milk drinks, fermented dairy drinks, coffee whiteners, powder milk, flavored powder milk drinks, cream, cheese, processed cheese, spreadable processed cheese, unspreadable processed cheese, unprocessed cheese, spreadable unprocessed cheese, hard cheese, packaged hard cheese, unpackaged hard cheese, yoghurt, plain/natural yoghurt, flavored yoghurt, fruited yoghurt, probiotic yoghurt, drinking yoghurt, regular drinking yoghurt, probiotic drinking yoghurt, chilled and shelf-stable desserts, dairy-based desserts, soy-based desserts, chilled snacks, fromage frais and quark, plain fromage frais and quark, flavored fromage frais and quark, savory fromage frais and quark, sweet and savory snacks, fruit snacks, chips/crisps, extruded snacks, tortilla/corn chips, popcorn, pretzels, nuts, other sweet and savory snacks, snack bars, granola bars, breakfast bars, energy bars, fruit bars, other snack bars, meal replacement products, slimming products, convalescence drinks, ready meals, canned ready meals, frozen ready meals, dried ready meals, chilled ready meals, dinner mixes, frozen pizza, chilled pizza, soup, canned soup, dehydrated soup, instant soup, chilled soup, hot soup, frozen soup, pasta, canned pasta, dried pasta, chilled/fresh pasta, noodles, plain noodles, instant noodles, cups/bowl instant noodles, pouch instant noodles, chilled noodles, snack noodles, canned food, canned meat and meat products, canned fish/seafood, canned vegetables, canned tomatoes, canned beans, canned fruit, canned ready meals, canned soup, canned pasta, other canned foods, frozen food, frozen processed red meat, frozen processed poultry, frozen processed fish/seafood, frozen processed vegetables, frozen meat substitutes, frozen potatoes, oven baked potato chips, other oven baked potato products, non-oven frozen potatoes, frozen bakery products, frozen desserts, frozen ready meals, frozen pizza, frozen soup, frozen noodles, other frozen food, dried food, dessert mixes, dried ready meals, dehydrated soup, instant soup, dried pasta, plain noodles, instant noodles, cups/bowl instant noodles, pouch instant noodles, chilled food, chilled processed meats, chilled fish/seafood products, chilled processed fish, chilled coated fish, chilled smoked fish, chilled lunch kit, chilled ready meals, chilled pizza, chilled soup, chilled/fresh pasta, chilled noodles, oils and fats, olive oil, vegetable and seed oil, cooking fats, butter, margarine, spreadable oils and fats, functional spreadable oils and fats, sauces, dressings and condiments, tomato pastes and purees, bouillon/stock cubes, stock cubes, gravy granules, liquid stocks and fonds, herbs and spices, fermented sauces, soy based sauces, pasta sauces, wet sauces, dry sauces/powder mixes, ketchup, mayonnaise, regular mayonnaise, mustard, salad dressings, regular salad dressings, low fat salad dressings, vinaigrettes, dips, pickled products, other sauces, dressings and condiments, baby food, milk formula, standard milk formula, follow-on milk formula, toddler milk formula, hypoallergenic milk formula, prepared baby food, dried baby food, other baby food, spreads, jams and preserves, honey, chocolate spreads, nut-based spreads, and yeast-based spreads. Exemplary ingestible compositions also include confectioneries, bakery products, ice creams, dairy products, sweet and savory snacks, snack bars, meal replacement products, ready meals, soups, pastas, noodles, canned foods, frozen foods, dried foods, chilled foods, oils and fats, baby foods, or spreads or a mixture thereof. Exemplary ingestible compositions also include breakfast cereals, sweet beverages or solid or liquid concentrate compositions for preparing beverages, ideally so as to enable the reduction in concentration of previously known saccharide sweeteners, or artificial sweeteners.

Some embodiments provide a chewable composition that may or may not be intended to be swallowed. In some embodiments, the chewable composition may be gum, chewing gum, sugarized gum, sugar-free gum, functional gum, bubble gum including compounds as disclosed and described herein, individually or in combination.

In some embodiments, the aqueous media disclosed herein may be provided in a flavoring concentrate formulation, e.g., suitable for subsequent processing to produce a ready-to-use (i.e., ready-to-serve) product. By “a flavoring concentrate formulation”, it is meant a formulation which should be reconstituted with one or more diluting medium to become a ready-to-use composition. The term “ready-to-use composition” is used herein interchangeably with “ingestible composition”, which denotes any substance that, either alone or together with another substance, can be taken by mouth whether intended for consumption or not. In one embodiment, the ready-to-use composition includes a composition that can be directly consumed by a human or animal. The flavoring concentrate formulation is typically used by mixing with or diluted by one or more diluting medium, e.g., any consumable or ingestible ingredient or product, to impart or modify one or more flavors to the diluting medium. Such a use process is often referred to as reconstitution. The reconstitution can be conducted in a household setting or an industrial setting. For example, a frozen fruit juice concentrate can be reconstituted with water or other aqueous medium by a consumer in a kitchen to obtain the ready-to-use fruit juice beverage. In another example, a soft drink syrup concentrate can be reconstituted with water or other aqueous medium by a manufacturer in large industrial scales to produce the ready-to-use soft drinks. Since the flavoring concentrate formulation has the flavoring agent or flavor modifying agent in a concentration higher than the ready-to-use composition, the flavoring concentrate formulation is typically not suitable for being consumed directly without reconstitution. There are many benefits of using and producing a flavoring concentrate formulation. For example, one benefit is the reduction in weight and volume for transportation as the flavoring concentrate formulation can be reconstituted at the time of usage by the addition of suitable solvent, solid or liquid.

The flavored products set forth according to any of the foregoing embodiments, also include, in certain embodiments, one or more additional flavor-modifying compounds, such as compounds that enhance sweetness (e.g., hesperetin, naringenin, glucosylated steviol glycosides, etc.), compounds that block bitterness, compounds that enhance umami, compounds that reduce sourness, compounds that enhance saltiness, compounds that enhance a cooling effect, or any combinations of the foregoing.

In certain embodiments of any aspects and embodiments set forth herein that refer to a sweetening or flavoring concentrate, the sweetening or flavoring concentrate is a non-naturally-occurring product, such as a composition specifically manufactured for the production of a flavored product, such as food or beverage product.

In one embodiment, the flavoring concentrate formulation comprises i) compounds as disclosed and described herein, individually or in combination; ii) a carrier; and iii) optionally at least one adjuvant. The term “carrier” denotes a usually inactive accessory substance, such as solvents, binders, or other inert medium, which is used in combination with the present compound and one or more optional adjuvants to form the formulation. For example, water or starch can be a carrier for a flavoring concentrate formulation. In some embodiments, the carrier is the same as the diluting medium for reconstituting the flavoring concentrate formulation; and in other embodiments, the carrier is different from the diluting medium. The term “carrier” as used herein includes, but is not limited to, ingestibly acceptable carrier.

The term “adjuvant” denotes an additive which supplements, stabilizes, maintains, or enhances the intended function or effectiveness of the active ingredient, such as the compound of the present invention. In one embodiment, the at least one adjuvant comprises one or more flavoring agents. The flavoring agent may be of any flavor known to one skilled in the art or consumers, such as the flavor of chocolate, coffee, tea, mocha, French vanilla, peanut butter, chai, or combinations thereof. In another embodiment, the at least one adjuvant comprises one or more sweeteners. The one or more sweeteners can be any of the sweeteners described in this application. In another embodiment, the at least one adjuvant comprises one or more ingredients selected from the group consisting of a emulsifier, a stabilizer, an antimicrobial preservative, an antioxidant, vitamins, minerals, fats, starches, protein concentrates and isolates, salts, and combinations thereof. Examples of emulsifiers, stabilizers, antimicrobial preservatives, antioxidants, vitamins, minerals, fats, starches, protein concentrates and isolates, and salts are described in U.S. Pat. No. 6,468,576, the content of which is hereby incorporated by reference in its entirety for all purposes.

In one embodiment, the present flavoring concentrate formulation can be in a form selected from the group consisting of liquid including solution and suspension, solid, foamy material, paste, gel, cream, and a combination thereof, such as a liquid containing certain amount of solid contents. In one embodiment, the flavoring concentrate formulation is in form of a liquid including aqueous-based and nonaqueous-based. In some embodiments, the present flavoring concentrate formulation can be carbonated or non-carbonated.

The flavoring concentrate formulation may further comprise a freezing point depressant, nucleating agent, or both as the at least one adjuvant. The freezing point depressant is an ingestibly acceptable compound or agent which can depress the freezing point of a liquid or solvent to which the compound or agent is added. That is, a liquid or solution containing the freezing point depressant has a lower freezing point than the liquid or solvent without the freezing point depressant. In addition to depress the onset freezing point, the freezing point depressant may also lower the water activity of the flavoring concentrate formulation. The examples of the freezing point depressant include, but are not limited to, carbohydrates, oils, ethyl alcohol, polyol, e.g., glycerol, and combinations thereof. The nucleating agent denotes an ingestibly acceptable compound or agent which is able to facilitate nucleation. The presence of nucleating agent in the flavoring concentrate formulation can improve the mouthfeel of the frozen Blushes of a frozen slush and to help maintain the physical properties and performance of the slush at freezing temperatures by increasing the number of desirable ice crystallization centers. Examples of nucleating agents include, but are not limited to, calcium silicate, calcium carbonate, titanium dioxide, and combinations thereof.

In one embodiment, the flavoring concentrate formulation is formulated to have a low water activity for extended shelf life. Water activity is the ratio of the vapor pressure of water in a formulation to the vapor pressure of pure water at the same temperature. In one embodiment, the flavoring concentrate formulation has a water activity of less than about 0.85. In another embodiment, the flavoring concentrate formulation has a water activity of less than about 0.80. In another embodiment, the flavoring concentrate formulation has a water activity of less than about 0.75.

In one embodiment, the flavoring concentrate formulation has the present compound in a concentration that is at least 2 times of the concentration of the compound in a ready-to-use composition. In one embodiment, the flavoring concentrate formulation has the present compound in a concentration that is at least 5 times of the concentration of the compound in a ready-to-use composition. In one embodiment, the flavoring concentrate formulation has the present compound in a concentration that is at least 10 times of the concentration of the compound in a ready-to-use composition. In one embodiment, the flavoring concentrate formulation has the present compound in a concentration that is at least 15 times of the concentration of the compound in a ready-to-use composition. In one embodiment, the flavoring concentrate formulation has the present compound in a concentration that is at least 20 times of the concentration of the compound in a ready-to-use composition. In one embodiment, the flavoring concentrate formulation has the present compound in a concentration that is at least 30 times of the concentration of the compound in a ready-to-use composition. In one embodiment, the flavoring concentrate formulation has the present compound in a concentration that is at least 40 times of the concentration of the compound in a ready-to-use composition. In one embodiment, the flavoring concentrate formulation has the present compound in a concentration that is at least 50 times of the concentration of the compound in a ready-to-use composition. In one embodiment, the flavoring concentrate formulation has the present compound in a concentration that is at least 60 times of the concentration of the compound in a ready-to-use composition. In one embodiment, the flavoring concentrate formulation has the present compound in a concentration that is up to 100 times of the concentration of the compound in a ready-to-use composition.

The sweetening or flavoring concentrates set forth according to any of the foregoing embodiments, also include, in certain embodiments, one or more additional flavor-modifying compounds, such as compounds that enhance sweetness (e.g., hesperetin, naringenin, glucosylated steviol glycosides, etc.), compounds that block bitterness (e.g., eriodictyol, homoeriodictyol, sterubin, and salts or glycoside derivatives thereof, as well as vanillyl lignans, e.g., matairesinol and other compounds set forth in PCT Publication No. WO 2012/146584), compounds that enhance umami (e.g., rubemamine, rubescenamine, (E) (3,4-dimethoxyphenyl)-N-(4-methoxyphenethyl)acrylamide, and the like), compounds that reduce sourness and/or licorice taste, compounds that enhance saltiness, compounds that enhance a cooling effect, or any combinations of the foregoing.

### Uses and Methods

In certain aspects, the disclosure provides uses of an anthocyanin composition, which comprises one or more anthocyanin compounds, to increase an aqueous solubility of a flavonoid compound. In some embodiments, the uses comprise introducing one or more anthocyanin compounds in combination with the flavonoid compound to an aqueous medium, according to any of the embodiments described above for aqueous media or compositions.

In certain aspects, the disclosure provides uses of an anthocyanin composition, which comprises one or more anthocyanin compounds, to inhibit or delay aqueous recrystallization of a flavonoid compound. In some embodiments, the uses comprise introducing one or more anthocyanin compounds in combination with the flavonoid compound to an aqueous medium, according to any of the embodiments described above for aqueous media or compositions.

In certain aspects, the disclosure provides uses of an anthocyanin composition, which comprises one or more anthocyanin compounds, to enhance a taste-modulating effect of a flavonoid compound. In some embodiments, the uses comprise introducing one or more anthocyanin compounds in combination with the flavonoid compound to an aqueous medium, according to any of the embodiments described above for aqueous media or compositions.

In certain aspects, the disclosure provides uses of an anthocyanin composition, which comprises one or more anthocyanin compounds, to increase a supersaturated aqueous stability of a flavonoid compound. In some embodiments, the uses comprise introducing one or more anthocyanin compounds in combination with the flavonoid compound to an aqueous medium, according to any of the embodiments described above for aqueous media or compositions.

In certain aspects, the disclosure provides methods of increasing aqueous solubility of a flavonoid compound, the method comprising introducing an anthocyanin composition in combination with a flavonoid compound to an aqueous medium, according to any of the embodiments described above for aqueous media or compositions.

In certain aspects, the disclosure provides methods of inhibiting or delaying aqueous recrystallization of a flavonoid compound, the method comprising introducing an anthocyanin composition in combination with a flavonoid compound to an aqueous medium, according to any of the embodiments described above for aqueous media or compositions.

In certain aspects, the disclosure provides methods of enhancing taste modulation of a flavonoid compound, the method comprising introducing an anthocyanin composition in combination with a flavonoid compound to an aqueous medium, according to any of the embodiments described above for aqueous media or compositions.

In certain aspects, the disclosure provides methods of increasing supersaturated aqueous stability of a flavonoid compound, the method comprising introducing an anthocyanin composition in combination with a flavonoid compound to an aqueous medium, according to any of the embodiments described above for aqueous media or compositions.

### EXAMPLES

To further illustrate this invention, the following examples are included. The examples should not, of course, be construed as specifically limiting the invention. Variations of these examples within the scope of the claims are within the purview of one skilled in the art and are considered to fall within the scope of the invention as described, and claimed herein. The reader will recognize that the skilled artisan, armed with the present disclosure, and skill in the art is able to prepare and use the invention without exhaustive examples.

Concentrations of anthocyanin extracts and of additional additives indicated refer to the total amount of the individual product in the final solution, and not to the concentration of the specific active ingredient.

### Example 1— Rhoifolin at 20 ppm Plus Anthocyanin

Aqueous solutions of various anthocyanin extracts were prepared at concentrations of 100 ppm, 200 ppm, and 300 ppm by dissolving dry anthocyanin extract in 99 g of buffer solution (citrate buffer, 100 mM, pH 2.8, 0.2% sodium benzoate). Then 1 gram of stock solution of rhoifolin in propylene glycol (PG) at 2000 ppm was added and mixed quickly with the aqueous phase. The samples were left at room temperature, and aliquots were removed over the course of three months. A control solution of rhoifolin without anthocyanin was also prepared.

To assess stability performance, the solution concentration of rhoifolin was determined over time. At specific time points 4 g of the solution were sampled, filtered and mixed with 1 g of acetonitrile. The solution was injected into a Vanquish UHPLC from Thermo Scientific coupled with a UV detector. The column was an Accucore Vanquish C18+(1.5 μm, 2.1×100 mm), eluted with a mixture of acetonitrile and water at 0.3 mL/min. The elution protocol was as follows: 5% acetonitrile (3 minutes), followed by a gradient from 5% to 80% of acetonitrile in 10 minutes. The corresponding peak of Rhoifolin was integrated, and the concentration was calculated based on a previously established calibration curve. The onset of crystallization is expressed as the point where the solution concentration passes below 95% of its initial value of 100%. The value was obtained by algorithmic curve fitting. Table 1 shows the results for the days of onset of crystallization. In this example, and throughout “d” refers to days.

TABLE 1

| | Control | 100 ppm | 200 ppm | 300 ppm |
|---|---|---|---|---|
| Extract | Onset (d) | Onset (d) | Onset (d) | Onset (d) |
| Control | 4.1 | | | |
| Bilberry extract 1) | | 7.5 | 12.2 | 13.9 |
| Berry extract 2) | | 8.6 | 18.4 | 18.8 |
| Black Rice Extract 3) | | 10.1 | 35.9 | 67.0 |
| Black Soybean Extract 4) | | 14.2 | 25.3 | 39.5 |

1) Bilberry Dry Extract, Buckton Scott, Germany.
2) Healthberry ® 865, Evonik
3) Black Rice Extract Powder, Beijing Gingko Group
4) Black Soybean Hull Extract Powder, Beijing Gingko Group

Table 2 shows the results for the number of days when only 50% of the initial concentration of rhoifolin remained in solution.

TABLE 2

| | Control | 100 ppm | 200 ppm | 300 ppm |
|---|---|---|---|---|
| | 50% | 50% | 50% | 50% |
| Extract | Rem (d) | Rem (d) | Rem (d) | Rem (d) |
| Control | 8.2 | | | |
| Bilberry extract | | 16.3 | 27.7 | 29.9 |
| Berry extract | | 16.2 | 35.2 | 39.0 |
| Black Rice extract | | 23.1 | 59.8 | >100 |
| Black Soybean extract | | 24.2 | 47.9 | 75.0 |

Table 3 shows the final concentration of rhoifolin in solution for certain samples with 300 ppm of extract.

TABLE 3

| Extract | Fin. Conc. (ppm) |
|---|---|
| Control | 3.3 |
| Bilberry extract | 5.4 |
| Berry extract | 5.4 |
| Black Rice extract | 10.6 |
| Black Soybean extract | 9.0 |

### Example 2— Rhoifolin at 20 ppm Plus Black Rice Extract and Additives

Aqueous solutions of black rice extract were prepared at a concentration of 100 ppm by dissolving dry black rice extract in 99 g of buffer solution (citrate buffer, 100 mM, pH 2.8, 0.2% sodium benzoate) with various additional additives. Then 1 gram of stock solution of rhoifolin in PG at 2000 ppm was added and mixed quickly with the aqueous phase. The samples were left at room temperature, and aliquots were removed over the course of 40 days. A control solution of rhoifolin without black rice or additional additives was also prepared. A solution with black rice, but no additional additive was also prepared. The concentration of the additional additives is 100 ppm in each case. Table 4 shows the crystallization onset, the number of days for 50% crystallization of rhoifolin, and the final concentration. Saponin is Quillaja P (Firmenich SA).

TABLE 4

| Additive | Onset (d) | 50% (d) | Fin. Conc. (ppm) |
|---|---|---|---|
| Control | 4.1 | 8.2 | 3.32 |
| No Additive | 8.3 | 16.6 | 5.71 |
| Rebaudioside A | 10.8 | 18.8 | 5.96 |
| Saponin | 13.7 | 24.1 | 7.75 |

### Example 3— Rhoifolin at 20 ppm Plus Additives

Aqueous solutions were prepared in 99 gram of buffer solution (citrate buffer, 100 mM, pH 2.8, 0.2% sodium benzoate) with various additives. Then 1 gram of stock solution of rhoifolin in PG at 2000 ppm was added and mixed quickly with the aqueous phase. The samples were left at room temperature, and aliquots were removed over the course of 40 days. A control solution of rhoifolin without additive was prepared. The concentration of the additives is 100 ppm in each case. Table 5 shows the crystallization onset, the number of days for 50% crystallization of rhoifolin, and the final concentration. Saponin is Quillaja P (Firmenich SA).

TABLE 5

| Additive | Onset (days) | 50% (days) | Fin. Conc. (ppm) |
|---|---|---|---|
| Control | 4.1 | 8.2 | 3.32 |
| Rebaudioside A | 7.5 | 13.6 | 4.04 |
| Saponin | 5.4 | 13.4 | 4.73 |

### Example 4— Naringenin at 60 ppm Plus Berry Extract

Aqueous solutions of Berry extract were prepared at a concentration of 25 ppm, 50 ppm, 75 ppm, and 100 ppm by dissolving dry Berry extract in 99 g of buffer solution (citrate buffer, 100 mM, pH 2.8, 0.2% sodium benzoate). Then 1 gram of stock solution of naringenin in PG at 6000 ppm was added and mixed quickly with the aqueous phase. The samples were stored at 8° C., and aliquots were removed over the course of 40 days. A control solution of naringenin without Berry extract was also prepared. Table 6 shows the crystallization onset and the final concentration.

TABLE 6

| Berry extract | Onset (d) | Fin. Conc. (ppm) |
|---|---|---|
| Control | 0.3 | 24.6 |
| 25 ppm | 4.6 | 32.4 |
| 50 ppm | 10.6 | 36.2 |
| 75 ppm | 14.6 | 37.7 |
| 100 ppm | 16.0 | 38.8 |

### Example 5— Naringenin at 60 ppm Plus Berry Extract and Additives

Aqueous solutions of Berry extract were prepared at a concentration of 100 ppm by dissolving dry Berry extract in 99 g of buffer solution (citrate buffer, 100 mM, pH 2.8, 0.2% sodium benzoate) with various additional additives. Then 1 gram of stock solution of naringenin in PG at 6000 ppm was added and mixed quickly with the aqueous phase. The samples were stored at 8° C., and aliquots were removed over the course of five months. A control solution of naringenin without Berry extract or additional additive was also prepared. A solution with Berry extract, but no additional additive was also prepared. The concentration of the additional additives is 100 ppm in each case. Table 7 shows the crystallization onset and the final concentration. Saponin is Quillaja P (Firmenich SA).

TABLE 7

| Additive | Onset (d) | Fin. Conc. (ppm) |
|---|---|---|
| Control | 0.3 | 24.6 |
| No Additive | 15.3 | 37.4 |
| Rebaudioside A | 15.8 | 34.1 |
| Saponin | >160 | 60.0 |

### Example 6— Naringenin at 60 ppm Plus Black Rice Extract and Additives

Aqueous solutions of black rice extracts were prepared at a concentration of 100 ppm by dissolving dry black rice extract in 99 g of buffer solution (citrate buffer, 100 mM, pH 2.8, 0.2% sodium benzoate) with various additional additives. Then 1 gram of stock solution of naringenin in PG at 6000 ppm was added and mixed quickly with the aqueous phase. The samples were stored at 8° C., and aliquots were removed over the course of five months. A control solution of naringenin without black rice extract or additional additive was also prepared. A solution with black rice extract, but no additional additive was also prepared. The concentration of the additional additives is 100 ppm in each case. Table 8 shows the crystallization onset and the final concentration. Saponin is Quillaja P (Firmenich SA).

TABLE 8

| Additive | Onset (d) | Fin. Conc. (ppm) |
|---|---|---|
| Control | 0.3 | 24.6 |
| No Additive | 6.5 | 32.5 |
| Rebaudioside A | 18.3 | 35.4 |
| Saponin | >160 | 60.0 |

### Example 7— Naringenin at 60 ppm Plus Additives

Aqueous solutions were prepared in 99 gram of buffer solution (citrate buffer, 100 mM, pH 2.8, 0.2% sodium benzoate) with various additives. Then 1 gram of stock solution of naringenin in PG at 6000 ppm was added and mixed quickly with the aqueous phase. The samples were stored at 8° C., and aliquots were removed over the course of 5 months. A control solution of naringenin without additive was prepared. The concentration of the additives is 100 ppm in each case. Table 9 shows the crystallization onset and the final concentration. Saponin is Quillaja P (Firmenich SA).

TABLE 9

| Additive | Onset (d) | Fin. Conc. (ppm) |
|---|---|---|
| Control | 0.3 | 24.6 |
| Rebaudioside A | 7.5 | 31.0 |
| Saponin | >160 | 60.0 |

### Example 8— Naringenin at 60 ppm Plus Berry Extract and Additives

Aqueous solutions of Berry extract were prepared at a concentration of 25 ppm by dissolving dry Berry extract in 99 g of buffer solution (citrate buffer, 100 mM, pH 2.8, 0.2% sodium benzoate) with various amounts of added saponin. Then 1 gram of stock solution of naringenin in PG at 6000 ppm was added and mixed quickly with the aqueous phase. The samples were stored at 8° C., and aliquots were removed over the course of five months. A control solution of naringenin without Berry extract or additional additive was also prepared. A solution with Berry extract, but no additional additive was also prepared. The concentration of the added saponin is 25 ppm, 50 ppm, and 75 ppm. Table 10 shows the crystallization onset and the final concentration. Saponin is Quillaja P (Firmenich SA)

TABLE 10

| Additive | Onset (d) | Fin. Conc. (ppm) |
|---|---|---|
| Control | 0.3 | 24.6 |
| Saponin 25 ppm | >145 | 60 |
| Saponin 50 ppm | >145 | 60 |
| Saponin 75 ppm | >145 | 60 |

### Example 9— Naringenin at 60 ppm Plus Saponin

Aqueous solutions were prepared in 99 gram of buffer solution (citrate buffer, 100 mM, pH 2.8, 0.2% sodium benzoate) with various concentrations of saponin. Then 1 gram of stock solution of naringenin in PG at 6000 ppm was added and mixed quickly with the aqueous phase. The samples were stored at 8° C., and aliquots were removed over the course of five months. A control solution of naringenin without saponin was prepared. The concentration of saponin was 25 ppm, 50 ppm, and 75 ppm. Table 11 shows the crystallization onset and the final concentration. Saponin is Quillaja P (Firmenich SA).

TABLE 11

| Additive | Onset (d) | Fin. Conc. (ppm) |
|---|---|---|
| Control | 0.3 | 24.6 |
| Saponin 25 ppm | >145 | 60 |
| Saponin 50 ppm | >145 | 60 |
| Saponin 75 ppm | >145 | 60 |

### Example 10— Phloretin at 60 ppm Plus Berry Extract

Aqueous solutions of Berry extract were prepared at a concentration of 25 ppm, 50 ppm, 75 ppm, and 100 ppm by dissolving dry Berry extract in 99 g of buffer solution (citrate buffer, 100 mM, pH 2.8, 0.2% sodium benzoate). Then 1 gram of stock solution of phloretin in PG at 6000 ppm was added and mixed quickly with the aqueous phase. The samples were stored at 8° C., and aliquots were removed over the course of three months. A control solution of phloretin without Berry extract was also prepared. Table 12 shows the crystallization onset and the final concentration.

TABLE 12

| Berry extract | Onset (d) | Fin. Conc. (ppm) |
|---|---|---|
| Control | 13.6 | 33.8 |
| 25 ppm | >100 | 60 |
| 50 ppm | >100 | 60 |
| 75 ppm | >100 | 60 |
| 100 ppm | >100 | 60 |

### Example 11— Phloretin at 60 ppm Plus Additives

Aqueous solutions were prepared in 99 gram of buffer solution (citrate buffer, 100 mM, pH 2.8, 0.2% sodium benzoate) with saponin. Then 1 gram of stock solution of phloretin in PG at 6000 ppm was added and mixed quickly with the aqueous phase. The samples stored at 8° C., and aliquots were removed over the course of 5 months. A control solution of phloretin without saponin was prepared. The concentration of saponin was 100 ppm. Table 13 shows the crystallization onset and the final concentration. Saponin is Quillaja P (Firmenich SA).

TABLE 13

| Additive | Onset (d) | Fin. Conc. (ppm) |
|---|---|---|
| Control | 13.6 | 33.8 |
| Saponin 100 ppm | 36.6 | 51.1 |

### Example 12— Concentrated Stock Solutions of Naringenin, Berry Extract and Saponin

2 Grams of naringenin, 1.67 grams of Berry extract and 1.67 grams of saponin solution or saponin powder were dissolved in 94.7 grams of PG. The final concentrations of naringenin, Berry extract and saponin are 20000 ppm, 16700 ppm, and 16700 ppm, respectively.

### Example 13: Preparation of a Beverage Base

An aqueous beverage base is prepared with a composition having the ingredients and relative concentrations set forth in Table 14.

TABLE 14

| Ingredient | Concentration |
|---|---|
| Sucrose | 4% |
| Citric acid | 0.07% |
| Flavor | 0.1% |
| Rebaudioside A | 150 ppm |

### Example 14: Preparation of a Beverage Containing Naringenin, Berry Extract and Saponin

0.3 gram of concentrated stock solution from Example 12 was mixed with 99.7 grams of a beverage base from Example 13. The final concentrations of naringenin, Berry extract and saponin in the beverage base are 60 ppm, 50 ppm, and 50 ppm, respectively.

### Example 15— Sensory Testing

Taste sensory tests were conducted using human evaluators. A reference sample of naringenin at 60 ppm was prepared. Test samples were prepared by further including the following additives, as shown in Table 14.

TABLE 15

| Sample | Additive |
|---|---|
| Test 1 | 50 ppm Quillaja P |
| Test 2 | 100 ppm Quillaja P |
| Test 3 | 50 ppm Berry extract |
| Test 4 | 100 ppm Berry extract |
| Test 5 | 50 ppm Berry extract + 50 ppm Quillaja P |
| Test 6 | 100 ppm Berry extract + 100 ppm Quillaja P |

The reference sample and the six test samples were tested for sweet lingering, licorice taste, sourness, and sweetness. As for sweet lingering, none of the test samples showed any significance from the reference. As for licorice taste, Test 1 and Test 4 showed a statistically significant difference in licorice taste masking relative to the reference. As for sourness, Test 2 showed a statistically significant difference from the reference in terms of sourness enhancement. As for sweetness, none of the test samples showed any significance from the reference. Notably, the mixture samples (Test 5 and Test 6) showed no statistically significant differences relative to the reference.

### Further Embodiments

In addition to the various aspects and embodiments set forth in the preceding sections, the present disclosure provides the following aspects and embodiments thereof. These aspects and embodiments are not exclusive of those set forth in the preceding sections and, may, in many instances, overlap in scope with the preceding aspects and embodiments. The following aspects and embodiments are provided as a supplement to those aspects and embodiments set forth above, and are not intended to limit the scope of the foregoing disclosure in any.

1. Use of a composition, which comprises one or more anthocyanin compounds, saponin compounds, or any combination thereof, to increase an aqueous solubility of a flavonoid compound.
2. Use of a composition, which comprises one or more anthocyanin compounds, saponin compounds, or any combination thereof, to inhibit or delay aqueous recrystallization of a flavonoid compound.
3. Use of a composition, which comprises one or more anthocyanin compounds, saponin compounds, or any combination thereof, to enhance a taste-modulating effect of a flavonoid compound.
4. Use of a composition, which comprises one or more anthocyanin compounds, saponin compounds, or any combination thereof, to increase a supersaturated aqueous stability of a flavonoid compound.
5. The use of any one of embodiments 1 to 5, wherein the use comprises introducing the one or more anthocyanin compounds, saponin compounds, or any combination thereof, in combination with the flavonoid compound to an aqueous medium.
6. The use of embodiment 5, wherein the use comprises introducing one or more anthocyanin compounds, and wherein, in some embodiments, the molar ratio of the one or more anthocyanins to the flavonoid in the aqueous medium ranges from 1:50 to 5:1, or from 1:20 to 5:1, or from 1:10 to 5:1, or from 1:5 to 5:1, or from 1:50 to 4:1, or from 1:20 to 4:1, or from 1:10 to 4:1, or from 1:5 to 4:1, or from 1:50 to 3:1, or from 1:20 to 3:1, or from 1:10 to 3:1, or from 1:5 to 3:1, or from 1:50 to 2:1, or from 1:20 to 2:1, or from 1:10 to 2:1, or from 1:5 to 2:1.
7. The use of embodiment 5 or 6, wherein the use comprises introducing one or more saponin compounds.
8. The use of embodiment 7, wherein the concentration of the one or more saponins in the aqueous medium ranges from 1 ppm to 5000 ppm, or from 1 ppm to 3000 ppm, or from 1 ppm to 2000 ppm, or from 1 ppm to 1000 ppm, or from 1 ppm to 500 ppm, or from 1 ppm to 300 ppm, or from 5 ppm to 100 ppm, or from 5 ppm to 50 ppm.
9. The use of any one of embodiments 5 to 8, wherein the concentration of the one or more anthocyanins in the aqueous medium ranges from 1 ppm to 5000 ppm, or from 1 ppm to 3000 ppm, or from 1 ppm to 2000 ppm, or from 1 ppm to 1000 ppm, or from 1 ppm to 500 ppm, or from 1 ppm to 300 ppm, or from 5 ppm to 100 ppm, or from 25 ppm to 300 ppm, or from 25 ppm to 200 ppm, or from 25 ppm to 100 ppm, or from 45 ppm to 300 ppm, or from 45 ppm to 200 ppm, or from 45 ppm to 100 ppm, or from 50 ppm to 300 ppm, or from 50 ppm to 200 ppm, or from 50 ppm to 100 ppm.
10. The use of any one of embodiments 5 to 9, wherein the concentration of the flavonoid in the aqueous medium ranges from 1 ppm to 1000 ppm, or from 1 ppm to 500 ppm, or from 1 ppm to 300 ppm, or from 5 ppm to 100 ppm, or from 25 ppm to 300 ppm, or from 25 ppm to 200 ppm, or from 25 ppm to 100 ppm, or from 45 ppm to 300 ppm, or from 45 ppm to 200 ppm, or from 45 ppm to 100 ppm, or from 50 ppm to 300 ppm, or from 50 ppm to 200 ppm, or from 50 ppm to 100 ppm.
11. The use of any one of embodiments 5 to 10, wherein the aqueous medium further comprises one or more sweeteners.
12. The use of embodiment 11, wherein the one or more sweeteners comprise sucrose, fructose, glucose, sugar alcohol (such as xylitol or erythritol), natural steviol glycoside (such as rebaudioside A, rebausioside D, or rebaudioside M), a mogroside (such as mogroside V, siamenoside, or mogroside IIIE), allulose, aspartame, sucralose, acesulfame K, cyclamate, saccharin, or any combinations thereof.
13. The use of any one of embodiments 5 to 12, wherein the aqueous medium further comprises glucosylated natural steviol glycosides (GSGs).
14. The use of any one of embodiments 5 to 13, further comprising one or more additional taste-modifying compounds, such as sweetness-enhancing compounds, umami-enhancing compounds, kokumi-enhancing compounds, bitter-reducing compounds, sourness-reducing compounds, and any combinations thereof.
15. The use of any one of embodiments 1 to 14, wherein the anthocyanin composition is a plant extract, such as an extract of one or more plants selected from the group consisting of blueberry, bilberry, cranberry, lingonberry, blackberry, black raspberry, red raspberry, blackcurrant, cherry, eggplant, black rice, black corn, black soybean, ube, Okinawan sweet potato, red cabbage, violet, peach, apple, and any combinations thereof.
16. The use of any one of embodiments 1 to 15, wherein the one or more anthocyanin compounds are compounds of formula (I):

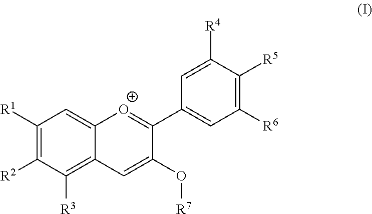

wherein:
R′, R², R³, R⁴, R⁵, and R⁶ are each independently —H, —OH, or —OCH₃; and
R⁷ is —H or a glucosyl moiety.
   17. The use of any one of embodiments 1 to 16, wherein the one or more anthocyanin compounds comprise cyanidin.
   18. The use of any one of embodiments 1 to 17, wherein the one or more anthocyanin compounds have a pKa of no higher than 5.0, or no higher than 4.5, or no higher than 4.0, or no higher than 3.5, or no higher than 3.0.
   19. The use of any one embodiments 1 to 18, wherein at least a portion of the one or more anthocyanin compounds, such as at least 10% by mole, or at least 20% by mole, or at least 30% by mole, or at least 40% by mole, or at least 50% by mole, are in their cationic form.
   20. The use of any one of embodiments 1 to 19, wherein the flavonoid compound is rhoifolin, neodiosmin, piloretin, hesperetin, naringenin, hesperetin dihydrochalcone, diosmin, neohesperidine dihydrochalcone, diosmetin, trilobatin dihydrochalcone, naringin dihydrochalcone, or any combinations thereof.
   21. The use of embodiment 20, wherein the flavonoid compound is hesperetin, naringenin, phloretin, or any combinations thereof.
   22. The use of any one of embodiments 5 to 21, wherein the aqueous medium further comprises one or more flavorings.
   23. The use of any one of embodiments 5 to 22, wherein the aqueous medium is not a naturally occurring composition.
   24. The use of any one of embodiments 5 to 23, wherein the aqueous medium is a dairy product, such as yogurt, dairy-based beverages, condensed milk, dairy-based protein drinks, dairy-based meal-replacement drinks, and the like, or a substitute dairy product, such as coconut milk, almond milk, soy milk, cashew milk, rice milk, oat milk, non-dairy-based protein drinks, non-dairy-based meal-replacement drinks, and the like.
   25. The use of any one of embodiments 5 to 23, wherein the aqueous medium is a beverage product, such as soda, energy drinks, kombucha, hard seltzer, and the like.
   26. The use of any one of embodiments 5 to 23, wherein the aqueous medium is a flavoring concentrate, such as a flavoring concentrate suitable for adding to compositions comprising water, soda, alcohol, or combinations thereof.
   27. The use of any one of embodiments 5 to 23, wherein the aqueous medium comprises surfactants, co-solvents, hydrotropes, and complexing agents, each at a concentration of no more than 1000 ppm, or no more than 500 ppm, or no more than 250 ppm, or no more than 100 ppm, or no more than 50 ppm, or no more than 30 ppm, or no more than 20 ppm, or no more than 10 ppm, or no more than 5 ppm.
   28. A method of increasing aqueous solubility of a flavonoid compound, the method comprising introducing a composition, which comprises one or more anthocyanin compounds, saponin compounds, or any combinations thereof, in combination with a flavonoid compound to an aqueous medium.
   29. A method of inhibiting or delaying aqueous recrystallization of a flavonoid compound, the method comprising introducing a composition, which comprises one or more anthocyanin compounds, saponin compounds, or any combinations thereof, in combination with a flavonoid compound to an aqueous medium.
   30. A method of enhancing taste modulation of a flavonoid compound, the method comprising introducing a composition, which comprises one or more anthocyanin compounds, saponin compounds, or any combinations thereof, in combination with a flavonoid compound to an aqueous medium.
   31. A method of increasing supersaturated aqueous stability of a flavonoid compound, the method comprising introducing a composition, which comprises one or more anthocyanin compounds, saponin compounds, or any combinations thereof, in combination with a flavonoid compound to an aqueous medium.
   32. The method of any one of embodiments 28 to 31, wherein composition comprises one or more anthocyanin compounds, and wherein, in some embodiments, the molar ratio of the one or more anthocyanins to the flavonoid in the aqueous medium ranges from 1:50 to 5:1, or from 1:20 to 5:1, or from 1:10 to 5:1, or from 1:5 to 5:1, or from 1:50 to 4:1, or from 1:20 to 4:1, or from 1:10 to 4:1, or from 1:5 to 4:1, or from 1:50 to 3:1, or from 1:20 to 3:1, or from 1:10 to 3:1, or from 1:5 to 3:1, or from 1:50 to 2:1, or from 1:20 to 2:1, or from 1:10 to 2:1, or from 1:5 to 2:1.
   33. The method of any one of embodiments 28 to 33, wherein the aqueous medium comprises one or more saponins.
   34. The method of embodiment 33, wherein the concentration of the one or more saponins in the aqueous medium ranges from 1 ppm to 5000 ppm, or from 1 ppm to 3000 ppm, or from 1 ppm to 2000 ppm, or from 1 ppm to 1000 ppm, or from 1 ppm to 500 ppm, or from 1 ppm to 300 ppm, or from 5 ppm to 100 ppm, or from 5 ppm to 50 ppm.
   35. The method of any one of embodiments 28 to 34, wherein the concentration of the one or more anthocyanins in the aqueous medium ranges from 1 ppm to 5000 ppm, or from 1 ppm to 3000 ppm, or from 1 ppm to 2000 ppm, or from 1 ppm to 1000 ppm, or from 1 ppm to 500 ppm, or from 1 ppm to 300 ppm, or from 5 ppm to 100 ppm, or from 25 ppm to 300 ppm, or from 25 ppm to 200 ppm, or from 25 ppm to 100 ppm, or from 45 ppm to 300 ppm, or from 45 ppm to 200 ppm, or from 45 ppm to 100 ppm, or from 50 ppm to 300 ppm, or from 50 ppm to 200 ppm, or from 50 ppm to 100 ppm.
   36. The method of any one of embodiments 28 to 35, wherein the concentration of the flavonoid in the aqueous medium ranges from 1 ppm to 1000 ppm, or from 1 ppm to 500 ppm, or from 1 ppm to 300 ppm, or from 5 ppm to 100 ppm, or from 25 ppm to 300 ppm, or from 25 ppm to 200 ppm, or from 25 ppm to 100 ppm, or from 45 ppm to 300 ppm, or from 45 ppm to 200 ppm, or from 45 ppm to 100 ppm, or from 50 ppm to 300 ppm, or from 50 ppm to 200 ppm, or from 50 ppm to 100 ppm.
   37. The method of any one of embodiments 28 to 36, wherein the aqueous medium further comprises one or more sweeteners.
   38. The method of embodiment 37, wherein the one or more sweeteners comprise sucrose, fructose, glucose, sugar alcohol (such as xylitol or erythritol), natural steviol glycoside (such as rebaudioside A, rebausioside D, or rebaudioside M), a mogroside (such as mogroside V, siamenoside, or mogroside IIIE), allulose, aspartame, sucralose, acesulfame K, cyclamate, saccharin, or any combinations thereof.
   39. The method of any one of embodiments 28 to 38, wherein the aqueous medium further comprises glucosylated natural steviol glycosides (GSGs).
   40. The method of any one of embodiments 28 to 39, further comprising one or more additional taste-modifying compounds, such as sweetness-enhancing compounds, umami-enhancing compounds, kokumi-enhancing compounds, bitter-reducing compounds, sourness-reducing compounds, and any combinations thereof.
   41. The method of any one of embodiments 28 to 40, wherein the anthocyanin composition is a plant extract, such as an extract of one or more plants selected from the group consisting of blueberry, bilberry, cranberry, lingonberry, blackberry, black raspberry, red raspberry, blackcurrant, cherry, eggplant, black rice, black corn, black soybean, ube, Okinawan sweet potato, red cabbage, violet, peach, apple, and any combinations thereof.
   42. The method of any one of embodiments 28 to 41, wherein the one or more anthocyanin compounds are compounds of formula (I):

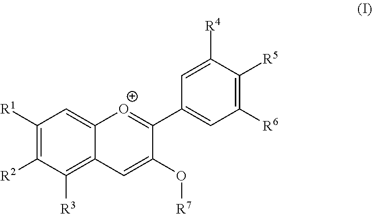

wherein:
R¹, R², R³, R⁴, R⁵, and R⁶ are each independently —H, —OH, or —OCH₃; and
R⁷ is —H or a glucosyl moiety.
   43. The method of any one of embodiments 28 to 42, wherein the one or more anthocyanin compounds comprise cyanidin.
   44. The method of any one of embodiments 28 to 43, wherein the one or more anthocyanin compounds have a pKa of no higher than 5.0, or no higher than 4.5, or no higher than 4.0, or no higher than 3.5, or no higher than 3.0.
   45. The method of any one embodiments 28 to 44, wherein at least a portion of the one or more anthocyanin compounds, such as at least 10% by mole, or at least 20% by mole, or at least 30% by mole, or at least 40% by mole, or at least 50% by mole, are in their cationic form.
   46. The method of any one of embodiments 28 to 45, wherein the flavonoid compound is rhoifolin, neodiosmin, pjloretin, hesperetin, naringenin, hesperetin dihydrochalcone, diosmin, neohesperidine dihydrochalcone, diosmetin, trilobatin dihydrochalcone, naringin dihydrochalcone, or any combinations thereof.
   47. The method of embodiment 46, wherein the flavonoid compound is hesperetin, naringenin, phloretin, or any combinations thereof.
   48. The method of any one of embodiments 28 to 47, wherein the aqueous medium further comprises one or more flavorings.
   49. The method of any one of embodiments 28 to 48, wherein the aqueous medium is not a naturally occurring composition.
   50. The method of any one of embodiments 28 to 49, wherein the aqueous medium is a dairy product, such as yogurt, dairy-based beverages, condensed milk, dairy-based protein drinks, dairy-based meal-replacement drinks, and the like, or a substitute dairy product, such as coconut milk, almond milk, soy milk, cashew milk, rice milk, oat milk, non-dairy-based protein drinks, non-dairy-based meal-replacement drinks, and the like.
   51. The method of any one of embodiments 28 to 49, wherein the aqueous medium is a beverage product, such as soda, energy drinks, kombucha, hard seltzer, and the like.
   52. The method of any one of embodiments 28 to 49, wherein the aqueous medium is a flavoring concentrate, such as a flavoring concentrate suitable for adding to compositions comprising water, soda, alcohol, or combinations thereof.
   53. The method of any one of embodiments 28 to 49, wherein the aqueous medium comprises surfactants, co-solvents, hydrotropes, and complexing agents, each at a concentration of no more than 1000 ppm, or no more than 500 ppm, or no more than 250 ppm, or no more than 100 ppm, or no more than 50 ppm, or no more than 30 ppm, or no more than 20 ppm, or no more than 10 ppm, or no more than 5 ppm.
   54. A comestible composition comprising:
an aqueous carrier, which comprises at least 50% by weight water;
a flavonoid compound, which is at least partially solvated by the aqueous carrier at a concentration greater than the saturation concentration of the flavonoid compound in water (for example, at 25° C. and 100 kPa); and
one or more anthocyanin compounds, saponin compounds, or any combinations thereof.
   55. The composition of embodiment 54, wherein the composition comprises one or more anthocyanin compounds, and wherein, in some embodiments, the molar ratio of the one or more anthocyanins to the flavonoid in the aqueous medium ranges from 1:50 to 5:1, or from 1:20 to 5:1, or from 1:10 to 5:1, or from 1:5 to 5:1, or from 1:50 to 4:1, or from 1:20 to 4:1, or from 1:10 to 4:1, or from 1:5 to 4:1, or from 1:50 to 3:1, or from 1:20 to 3:1, or from 1:10 to 3:1, or from 1:5 to 3:1, or from 1:50 to 2:1, or from 1:20 to 2:1, or from 1:10 to 2:1, or from 1:5 to 2:1.
   56. The composition of embodiment 54 or 55, wherein the aqueous medium comprises one or more saponins.
   57. The composition of embodiment 56, wherein the concentration of the one or more saponins in the aqueous medium ranges from 1 ppm to 5000 ppm, or from 1 ppm to 3000 ppm, or from 1 ppm to 2000 ppm, or from 1 ppm to 1000 ppm, or from 1 ppm to 500 ppm, or from 1 ppm to 300 ppm, or from 5 ppm to 100 ppm, or from 5 ppm to 50 ppm.
   58. The composition of any one of embodiments 54 to 57, wherein the concentration of the one or more anthocyanins in the aqueous medium ranges from 1 ppm to 5000 ppm, or from 1 ppm to 3000 ppm, or from 1 ppm to 2000 ppm, or from 1 ppm to 1000 ppm, or from 1 ppm to 500 ppm, or from 1 ppm to 300 ppm, or from 5 ppm to 100 ppm, or from 25 ppm to 300 ppm, or from 25 ppm to 200 ppm, or from 25 ppm to 100 ppm, or from 45 ppm to 300 ppm, or from 45 ppm to 200 ppm, or from 45 ppm to 100 ppm, or from 50 ppm to 300 ppm, or from 50 ppm to 200 ppm, or from 50 ppm to 100 ppm.
   59. The composition of any one of embodiments 54 to 58, wherein the concentration of the flavonoid in the aqueous medium ranges from 1 ppm to 1000 ppm, or from 1 ppm to 500 ppm, or from 1 ppm to 300 ppm, or from 5 ppm to 100 ppm, or from 25 ppm to 300 ppm, or from 25 ppm to 200 ppm, or from 25 ppm to 100 ppm, or from 45 ppm to 300 ppm, or from 45 ppm to 200 ppm, or from 45 ppm to 100 ppm, or from 50 ppm to 300 ppm, or from 50 ppm to 200 ppm, or from 50 ppm to 100 ppm.
   60. The composition of any one of embodiments 54 to 59, wherein the aqueous medium further comprises one or more sweeteners.
   61. The composition of embodiment 60, wherein the one or more sweeteners comprise sucrose, fructose, glucose, sugar alcohol (such as xylitol or erythritol), natural steviol glycoside (such as rebaudioside A, rebausioside D, or rebaudioside M), a mogroside (such as mogroside V, siamenoside, or mogroside IIIE), allulose, aspartame, sucralose, acesulfame K, cyclamate, saccharin, or any combinations thereof.
   62. The composition of any one of embodiments 54 to 61, wherein the aqueous medium further comprises glucosylated natural steviol glycosides (GSGs).
   63. The composition of any one of embodiments 54 to 62, further comprising one or more additional taste-modifying compounds, such as sweetness-enhancing compounds, umami-enhancing compounds, kokumi-enhancing compounds, bitter-reducing compounds, sourness-reducing compounds, and any combinations thereof.
   64. The composition of any one of embodiments 54 to 63, wherein the anthocyanin composition is a plant extract, such as an extract of one or more plants selected from the group consisting of blueberry, bilberry, cranberry, lingonberry, blackberry, black raspberry, red raspberry, blackcurrant, cherry, eggplant, black rice, black corn, black soybean, ube, Okinawan sweet potato, red cabbage, violet, peach, apple, and any combinations thereof.
   65. The composition of any one of embodiments 54 to 64, wherein the one or more anthocyanin compounds are compounds of formula (I):

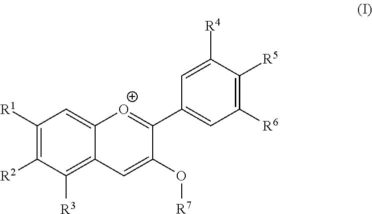

wherein:
R′, R², R³, R⁴, R⁵, and R⁶ are each independently —H, —OH, or —OCH₃; and
R⁷ is —H or a glucosyl moiety.
   66. The composition of any one of embodiments 54 to 65, wherein the one or more anthocyanin compounds comprise cyanidin.
   67. The composition of any one of embodiments 54 to 66, wherein the one or more anthocyanin compounds have a pKa of no higher than 5.0, or no higher than 4.5, or no higher than 4.0, or no higher than 3.5, or no higher than 3.0.
   68. The composition of any one embodiments 54 to 67, wherein at least a portion of the one or more anthocyanin compounds, such as at least 10% by mole, or at least 20% by mole, or at least 30% by mole, or at least 40% by mole, or at least 50% by mole, are in their cationic form.
   69. The composition of any one of embodiments 54 to 68, wherein the flavonoid compound is rhoifolin, neodiosmin, pjloretin, hesperetin, naringenin, hesperetin dihydrochalcone, diosmin, neohesperidine dihydrochalcone, diosmetin, trilobatin dihydrochalcone, naringin dihydrochalcone, or any combinations thereof.
   70. The composition of embodiment 69, wherein the flavonoid compound is hesperetin, naringenin, phloretin, or any combinations thereof.
   71. The composition of any one of embodiments 54 to 70, wherein the aqueous medium further comprises one or more flavorings.
   72. The composition of any one of embodiments 54 to 71, wherein the aqueous medium is not a naturally occurring composition.
   73. The composition of any one of embodiments 54 to 72, wherein the aqueous medium is a dairy product, such as yogurt, dairy-based beverages, condensed milk, dairy-based protein drinks, dairy-based meal-replacement drinks, and the like, or a substitute dairy product, such as coconut milk, almond milk, soy milk, cashew milk, rice milk, oat milk, non-dairy-based protein drinks, non-dairy-based meal-replacement drinks, and the like.
   74. The composition of any one of embodiments 54 to 72, wherein the aqueous medium is a beverage product, such as soda, energy drinks, kombucha, hard seltzer, and the like.
   75. The composition of any one of embodiments 54 to 72, wherein the aqueous medium is a flavoring concentrate, such as a flavoring concentrate suitable for adding to compositions comprising water, soda, alcohol, or combinations thereof.
   76. The composition of any one of embodiments 54 to 72, wherein the aqueous medium comprises surfactants, co-solvents, hydrotropes, and complexing agents, each at a concentration of no more than 1000 ppm, or no more than 500 ppm, or no more than 250 ppm, or no more than 100 ppm, or no more than 50 ppm, or no more than 30 ppm, or no more than 20 ppm, or no more than 10 ppm, or no more than 5 ppm.
   77. A beverage product, the product comprising a comestible composition of any one of embodiments 54 to 76.
   78. The beverage product of embodiment 77, further comprising one or more ingredients selected from the group consisting of: a flavoring, citric acid, ascorbic acid, carbonic acid, alcohol, a coloring, or any combinations thereof.
   79. The beverage product of embodiment 77 or 78, wherein the beverage product is a dairy product or a substitute dairy product, such as a protein drink, almond milk, coconut milk, cashew milk, soy milk, and the like.
   80. The beverage product of embodiment 77 or 78, wherein the beverage product is a soda.
   81. A flavoring concentrate, the flavoring concentrate comprising a comestible composition of any one of embodiments 54 to 76.

1. A method of increasing aqueous solubility of a flavonoid compound, the method comprising introducing to an aqueous medium comprising a flavonoid composition one or more anthocyanin compounds, saponin compounds, or any combinations thereof, to increase an aqueous solubility of the flavonoid compound, wherein a molar ratio of the one or more anthocyanins, saponin compounds, or any combinations thereof, to the flavonoid compound in the aqueous medium ranges from 1:50 to 50:1.

2-6. (canceled)

7. The method of claim 1, wherein the method comprises introducing one or more saponin compounds in combination with the flavonoid compound to the aqueous medium.

8. The method of claim 7, wherein the aqueous medium further comprises one or more sweeteners.

9. The method of claim 7, further comprising one or more additional taste-modifying compounds, such as sweetness-enhancing compounds, umami-enhancing compounds, kokumi-enhancing compounds, bitter-reducing compounds, sourness-reducing compounds, and any combinations thereof.

10. The method of claim 1, wherein the anthocyanin composition is a plant extract, such as an extract of one or more plants selected from the group consisting of blueberry, bilberry, cranberry, lingonberry, blackberry, black raspberry, red raspberry, blackcurrant, cherry, eggplant, black rice, black corn, black soybean, ube, Okinawan sweet potato, red cabbage, violet, peach, apple, and any combinations thereof.

11. The method of claim 1, comprising introducing one or more anthocyanin compounds to the aqueous medium, wherein the one or more anthocyanin compounds are compounds of formula (I): 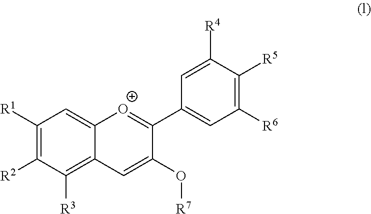
wherein:
R¹, R², R³, R⁴, R⁵, and R⁶ are each independently —H, —OH, or —OCH₃; and
R⁷ is —H or a glucosyl moiety.

12. The method of claim 11, wherein the one or more anthocyanin compounds comprise cyanidin.

13. The method of claim 11, wherein the flavonoid compound is hesperetin, naringenin, phloretin, rhoifolin, or any combinations thereof.

14. The method of claim 1, wherein the aqueous medium is a dairy product.

15. The method of claim 1, wherein the aqueous medium comprises any surfactants, co-solvents, hydrotropes, or complexing agents, each at a concentration of no more than 1000 ppm.
